(19) United States
(12) Patent Application Publication
(10) Pub. No.: US 2008/0309260 A1
(43) Pub. Date: Dec. 18, 2008

(54) Shaft Type Linear Motor, Mounting Head and Component Mounting Device With the Linear Motor, and Position Detection Method for Shaft for Driving the Linear Motor

(76) Inventors: Kazunori Kanai, Yamanashi (JP); Hidehiro Saho, Saga (JP); Noboru Yamasaki, Fukuoka (JP); Chikara Takata, Fukuoka (JP); Seiichi Matsuo, Fukuoka (JP); Yoshikazu Higuchi, Fukuoka (JP)

Correspondence Address: WENDEROTH, LIND & PONACK L.L.P., 2033 K. STREET, NW, SUITE 800, WASHINGTON, DC, 20006, US

(21) Appl. No.: 11/658,447

(22) PCT Filed: Jul. 6, 2005
(86) PCT No.: PCT/JP05/12491

§ 371 Date: Jan. 26, 2007

(30) Foreign Application Priority Data
Jul. 29, 2004 (JP) 2004-221482
Dec. 24, 2004 (JP) 2004-374075

(51) Int. Cl. H02K 41/03; H02P 6/16; B23P 19/04

(52) U.S. Cl. 318/38; 318/135; 318/400.04; 29/740; 310/12

(57) ABSTRACT

A shaft type linear motor including a stator in which plural hollow cylindrical coils are disposed so that the center through holes thereof are arranged linearly so as to form a shaft insertion hole; a driving shaft including permanent magnets, the same magnetic poles, the north or south magnetic poles, being disposed in the axial direction so as to be opposed to each other, and movably inserted into the stator; sensor units disposed in the axial direction of the stator so as to have a predetermined clearance therebetween and equipped with plural magnetic pole detection sensors that detect the magnetic field intensities of the permanent magnets and output magnetic field intensity signals; and a detection section for receiving the magnetic field intensity signals output from the magnetic pole detection sensors and for detecting the position of the driving shaft on the basis of the plural magnetic field intensity signals.

### TECHNICAL FIELD

The present invention relates to a shaft type linear motor having a driving shaft performing linear motion, a mounting head using the shaft type linear motor, a component mounting device using the mounting head, and a detection method for detecting the movement position of the shaft for driving the shaft type linear motor.

### BACKGROUND ART

A shaft type linear motor comprising a stator and a driving shaft has been known conventionally, for example as disclosed in Japanese Unexamined Patent Publication No. 10-313566. This kind of linear motor has a movable section formed of plural permanent magnets combined in series so that the same magnetic poles are opposed to each other and a stator section disposed so as to externally enclose this movable section and including coils capable of sliding the movable section in the axial direction. When a current is passed through the coil so as to intersect the lines of magnetic force of the magnetic field generated from the permanent magnet, a drive force is generated in the axial direction in the coil on the basis of the interaction between the current and the magnetic field, whereby the movable section is moved.

When such linear motors are used for precision apparatuses, such as factory automation apparatuses, the positioning accuracy of the movable section becomes an issue. As a position detection method for improving the positioning accuracy of the linear motor, a method of using a configuration that uses a linear scale for optically detecting the position is disclosed in Japanese Unexamined Patent Publication No. 2000-262034, and a method of using a configuration that uses a linear resolver is disclosed in Japanese Unexamined Patent Publication No. 2003-32955.

However, the linear scale using an optical position detector is expensive in price, and this poses an obstacle to reducing the price of the shaft type linear motor. In addition, high clearance control is required between the linear scale and a reading head. On the other hand, in the case of the linear motor using the linear resolver, since a shaft is provided separately for the resolver, there is a issue of making the structure complicated and large in size; furthermore, since the stroke of the motor depends on the shaft length of the resolver, there is a issue of being unable to attain a stroke exceeding the shaft length of the resolver.

Furthermore, a linear motor in which the movable section thereof has driving magnetized sections and position detection magnetized sections, and the stator section thereof has driving coils and position detection magnetic sensors is disclosed in Japanese Unexamined Patent Publication No. 7-107706. This linear motor is equipped with the position detection magnetized sections disposed more accurately in addition to the driving magnetized sections to improve the accuracy of detecting the position of the movable section.

### DISCLOSURE OF THE INVENTION

### Problem to be Solved by the Invention

However, the technology disclosed in Japanese Unexamined Patent Publication No. 7-107706 has a problem that the driving magnetized sections and the position detection magnetized sections must be provided independently for the movable section and that the driving coils and the position detection magnetic sensors must be provided independently for the stator. More specifically, the technology is difficult to implement because the driving magnetized sections disposed at a pitch of 10 mm and the position detection magnetized sections disposed at a pitch of 10 μm must be provided for one movable shaft. Furthermore, for the purpose of improving the position accuracy of the movable section, the position detection magnetized sections must be disposed at further smaller pitches, whereby the configuration is made more complicated.

Furthermore, since the driving magnetized sections and the position detection magnetized sections are provided for the movable section and the respective magnetized sections must be positioned so as to be opposed to the driving coils and the position detection magnetic sensors of the stator; this has a issue that it is difficult to use a shaft type linear motor having a configuration in which the movable shaft is rotatable with respect to the stator.

Accordingly, the present invention is intended to solve technical issues by providing a shaft type linear motor capable of rotating a shaft and capable of carrying out accurate position detection using a compact and simple configuration; a mounting head using the shaft type linear motor; a component mounting device using the mounting head; and a detection method for detecting the movement position of the movable section of the shaft type linear motor.

### SUMMARY OF THE INVENTION

The present invention provides a shaft type linear motor configured as described below to solve the technical issues described above.

According to the first aspect of the present invention, there is provided a shaft type linear motor comprising:

a hollow stator formed of plural ring-shaped coils being disposed concentrically and linearly;

a driving shaft provided with north and south magnetic poles being disposed alternately at approximately equal intervals in an axial direction thereof and inserted into a hollow section of the stator, for moving in the axial direction owing to interaction between the plural coils and the magnetic poles;

a sensor unit including at least a pair of magnetic detection sensors disposed with a predetermined clearance provided therebetween in the axial direction so as to be opposed to an outer circumferential face of the driving shaft, for outputting magnetic field intensities of the poles provided for the driving shaft, detected by the respective magnetic detection sensors, as magnetic field intensity signals; and

a detection section for receiving the output plural magnetic field intensity signals and detecting a movement position of the driving shaft with respect to the stator based on the magnetic field intensity signals.

The magnetic poles provided for the driving shaft can be formed of magnetic poles magnetized on the driving shaft itself. Alternatively, the driving shaft comprises a rod-shaped core member and permanent magnets disposed so as to externally cover the rod-shaped core member, and the magnetic poles provided for the driving shaft can be formed of the magnetic poles of the permanent magnets for the external covering. Furthermore, it is also possible that the driving shaft comprises plural permanent magnets stacked and secured continuously in the axial direction so that the same poles thereof, the south magnetic poles or the north magnetic poles, are brought into contact with each other, and the magnetic poles provided for the driving shaft can be formed of the poles of the plural permanent magnets.

A second aspect of the present invention provides the shaft type linear motor according to the first aspect characterized in that the stator has bearing sections for restraining deviation of the driving shaft in a direction intersecting the axis of the driving shaft or restraining inclination of the driving shaft with respect to the axis.

A third aspect of the present invention provides the shaft type linear motor according to the first aspect characterized in that at least two magnetic pole detection sensors of the sensor unit is disposed with a clearance provided therebetween in the axial direction so that in a case where one of the magnetic pole detection sensors detects an approximately maximum or minimum magnetic field intensity, the other magnetic pole detection sensor detects an approximately zero magnetic field intensity.

A fourth aspect of the present invention provides the shaft type linear motor according to the first aspect characterized in that the sensor unit is provided plural units disposed radially around a center axis of the hollow section of the stator, and that the detection section detects the movement position of the driving shaft while correcting a deviation of the driving shaft in a direction intersecting the axis of the driving shaft or correcting the change in the magnetic field intensities due to the inclination of the driving shaft with respect to the axis based on the plural magnetic field intensity signals output from the respective plural sensor units.

A fifth aspect of the present invention provides the shaft type linear motor according to the first aspect characterized in that the detection section stores a movement amount of the driving shaft corresponding to a length between the magnetic poles provided for the driving shaft and corrects the position of the driving shaft at detecting a position detection of the driving shaft.

A sixth aspect of the present invention provides a multi-shaft type linear motor comprising a plurality of the shaft type linear motors according to any one of the first to fifth aspects disposed in parallel with the axis thereof. The multi-shaft type linear motor can further comprise magnetic force shielding member for eliminating trouble due to magnetic forces between adjacent shaft type linear motors among the plural shaft type linear motors. The magnetic force shielding member can be made of a ferromagnetic material that is disposed between the adjacent shaft type linear motors so that the lines of magnetic force generated from one shaft type linear motor does not interact with the lines of magnetic force generated from the shaft type linear motors being adjacent thereto. In a case where the shaft type linear motor is adjacent to another shaft type linear motor only on one side and no shaft type linear motor is present on the other side being axially symmetrical with the one side, it is desirable that the magnetic force shielding member may also be provided on the other side.

A seventh aspect of the present invention provides a mounting head comprising the shaft type linear motor according to any one of the first to fifth aspects, a spline shaft connected to the driving shaft of the shaft type linear motor, a nozzle section connected to the spline shaft and being capable of holding components by suction, and a ball spline nut being fitted on the spline shaft, rotatably sliding along the spline shaft, and connected to a rotation drive source, wherein the height position of the nozzle section can be detected by the detection section of the shaft type linear motor.

An eighth aspect of the present invention provides the mounting head according to the seventh aspect characterized in that the sensor unit of the shaft type linear motor is disposed between the coil and the ball spline nut.

A ninth aspect of the present invention provides the mounting head according to the sixth aspect characterized in that the driving shaft and the spline shaft are respectively hollow and integrally connected to each other, and that an air suction path is formed from an upper end of the driving shaft to the nozzle section to communicate the upper end with the nozzle section.

A 10th aspect of the present invention provides a component mounting device comprising component feeding sections for feeding components continuously; a mounting head for taking out the components from the component feeding sections and mounting the components on circuit boards; robots for transferring the mounting head, a board transferring/holding device for loading and holding circuit boards; and a mounting controller for controlling the whole operations, the component mounting device being configured to take out components from the component feeding sections by suction and to mount the components at mounting positions on the circuit board by blowing using the nozzle sections installed in the mounting heads, wherein the mounting head is the mounting head according to the seventh aspect.

An 11th aspect of the present invention provides a detection method for detecting the movement position of the driving shaft of the shaft type linear motor, wherein the driving shaft for which north and south magnetic poles are provided and magnetized alternately with a predetermined clearance provided therebetween in the axial direction is inserted into the hollow stator comprising the plural coils, and the driving shaft is moved in the axial direction by the interaction between the plural coils and the magnetic poles provided for the driving shaft, wherein the detection is detecting the magnetic field intensity of the magnetic poles provided for the driving shaft using at least a part of magnetic pole detection sensors disposed on the stator side with a predetermined clearance provided therebetween in the axial direction and to detect the movement position of the driving shaft on the basis of the result of the detection of the respective sensors. At least the pair of magnetic pole detection sensors is disposed with a clearance provided therebetween so that when one of the magnetic pole detection sensors detects approximately maximum or minimum magnetic field intensity, the other magnetic pole detection sensor detects approximately zero magnetic field intensity.

### EFFECT OF THE INVENTION

According to the first and 11th aspects of the present invention, plural coils having preferably circular through holes at the center, such as ring-shaped coils, are arranged, and a cylindrical driving shaft is inserted into the through holes. Hence, the clearance between the driving shaft and the coils positioned therearound can be maintained nearly constant. Furthermore, the same pole of a permanent magnet is disposed so as to extend in the circumferential direction, preferably around the whole circumference. The magnetic poles provided for the driving shaft may be configured so that plural cylindrical magnets having a uniform length are incorporated in a rod-shaped core member or so that sheet-like permanent magnets are disposed around a rod-shaped core member so as to externally cover the core member. Furthermore, the driving shaft may also be configured so as to be magnetized directly.

The magnetic poles are provided for the driving shaft so as to be arranged in the axial direction of the driving shaft while the same poles are opposed to each other. Hence, a magnetic field having an intensity distribution with a nearly sine waveform is formed around the driving shaft along the driving shaft on the basis of the magnetic field of the permanent magnet. For this reason, even when the driving shaft is rotated around the axis with respect to the coils, the clearance between the driving shaft and the coils remains unchanged, and the driving thrust force of the linear motor is not adversely affected. The size of the permanent magnets disposed for the driving shaft may be designed appropriately according to the use and size of the linear motor; furthermore, provided that at least two permanent magnets are disposed, a magnetic field period with one pole being used at both ends is formed, and a linear motor can thus be attained.

In addition, in the aspect described above, since the sensor units having plural magnetic pole detection sensors and provided at positions different in the axial direction are used to detect the magnetic fields of the driving permanent magnets, and the position is detected on the basis of the outputs of the two sensor units; since the position detection is carried out in the magnetic field period, it is not necessary to separately provide magnetized portions for position detection; hence, the position of the driving shaft can be detected using a simple configuration.

In the second aspect of the present invention, it is desirable that the bearing section may be provided at each of both ends of the plural coils, and that the sensor unit may be provided very close to the bearing section. In this aspect, since the driving shaft is guided using the bearing sections so as not to be deviated in a direction intersecting the axis or not to be inclined with respect to the axis, the change of the clearance between the coils and the driving shaft is restrained to minimum extent to reduce influence on the outputs of the sensor units, whereby the accuracy of the position detection can be improved.

In the third aspect of the present invention, the two magnetic pole detection sensors are disposed at positions in which the detected magnetic field intensity values have a constant phase difference, and arithmetic processing can be carried out for the position detection in the magnetic field period. Particularly preferably, when the two magnetic pole detection sensors are disposed so that when one of the magnetic pole detection sensors detects approximately maximum or minimum magnetic field intensity, the other magnetic pole detection sensor detects approximately zero magnetic field intensity, the two magnetic pole detection sensors are thus disposed such that the phases of the magnetic field periods for the driving shaft are shifted by π/2 from each other; hence, the intensity can be subjected to arithmetic processing as an inner cycle angle using orthogonal coordinates. Hence, the position detection in the magnetic field period can be made simple and accurate.

In the fourth aspect of the present invention, since the plural sensor units are disposed around the same circumference having its center on the center axis of the axis insertion hole of the stator and being present in the plane perpendicular to the center axis, even when the driving shaft is deviated from the axis insertion hole or even when there is a difference in the size of the poles at the positions in the rotation direction of the driving shaft, the total distance of the clearance distances between the respective sensor units and the driving shaft does not change significantly. In other words, when the driving shaft is deviated so as to become close to one of the sensor units, the driving shaft becomes away from the other sensor unit, and the total of the outputs of the two sensor units is canceled. Hence, on the basis of the outputs of the plural sensor units, the outputs are corrected, whereby an adverse effect on the position detection due to the deviation of the driving shaft can be reduced. More specifically, for the output correction, on the basis of the addition average value of the output values of the respective magnetic pole detection sensors of the respective sensor units, for example, the position detection of the driving shaft can be carried out.

When three sensor units are disposed around approximately the same circumference at equal intervals, even if the driving shaft is deviated in any direction, the position can be detected properly by canceling the outputs of the respective sensor units. In addition, even when the plural sensor units provided around nearly the same circumference are not disposed at equal intervals, the position can be detected by carrying out correction depending on positions of the sensor units.

According to the fifth aspect of the present invention, the accuracy of the position detection of the driving shaft can be improved by storing the magnetic field period length each time the change of the magnetic poles, the north and south poles, of the driving shaft is repeated at the detection section. In other words, in the linear motor according to this aspect, since the position of the driving shaft is detected on the basis of the position in the magnetic field period, more accurate position detection of the driving shaft can be carried out by storing the information regarding magnetic field period length. In particular, when the clearances between the north and south poles disposed continuously have slight differences, and as a result, the magnetic field period length has variations, an adverse effect on the positioning accuracy due to the variations can be reduced.

According to the sixth aspect of the present invention, the multi-shaft type linear motor comprising the multi-shaft type linear motors described above is used and the respective shaft type linear motors are controlled independently, whereby plural operations can be carried out simultaneously. With the magnetic force shielding member provided to eliminate trouble due to magnetic forces between the adjacent shaft type linear motors, trouble on the operation control for the respective shaft type linear motors can be avoided, and the shaft type linear motors can be disposed close to one another, whereby the whole actuator can be made compact.

According to the seventh aspect of the present invention, in the linear motor according to the first to sixth aspects, since an adverse effect on the position detection is reduced even when the shaft is rotated with respect to the axis of the shaft, the seventh aspect can be used preferably for a mounting head, the driving shaft of which is required to be rotated for the rotation in the mounting direction. In addition, the mounting head can also be made compact by using compact linear motors, in which the magnetic fields of the driving permanent magnets for the driving shafts are used, as mechanisms for the height detection of the nozzle sections. Since the nozzle section provided at the tip of the mounting head is required to be moved vertically in the axial direction of the driving shaft, it is preferable that the spline shaft and the ball spline nut may be used to hold the driving shaft so that the driving shaft can rotate around the axis and move in the axial direction.

According to the eighth aspect of the present invention, since the shaft type linear motor, the sensor unit, the spline shaft, and the nozzle section are installed in this order from upper side, the mounting head can be configured so as to be most compact.

According to the ninth aspect of the present invention, since the driving shaft and the spline shaft are configured so as to be hollow and nozzle suction is performed from the upper portion of the shaft, no air rotation joint or solenoid valve is necessary, and the mounting head can be made more compact.

According to the 10th aspect of the present invention, since the mounting head configured so as to be compact is used, the component mounting device itself can be made lightweight and compact; hence, drive energy can be reduced, and the transfer speed can be improved.

### BRIEF DESCRIPTION OF DRAWINGS

These and other aspects and features of the present invention will become clear from the following description taken in conjunction with the preferred embodiments thereof with reference to the accompanying drawings, in which:

FIG. 1 is an overall schematic perspective view showing a component mounting device according to an embodiment of the present invention;

FIG. 2 is a schematic perspective view showing the XY robots of the component mounting device shown in FIG. 1;

FIG. 3A is a sectional view showing the XY robot, taken on line III-III of FIG. 2;

FIG. 3B is a side view showing the X-axis section of the XY robot shown in FIG. 3A;

FIG. 4 is a perspective view showing an appearance configuration of the first mounting head of the component mounting device shown in FIG. 1;

FIG. 5 is a view showing the θ-rotation mechanism for the suction nozzle assemblies of the first mounting head shown in FIG. 4;

FIG. 6 is a Y-direction sectional view showing the first mounting head shown in FIG. 4;

FIG. 7A is a fragmentary magnified sectional view showing the actuator of the first mounting head shown in FIG. 4;

FIG. 7B is a sectional view showing the actuator, taken on line VII-VII of FIG. 7A;

FIG. 8 is a fragmentary magnified perspective view showing the first mounting head shown in FIG. 4;

FIG. 9A is a block diagram showing a control circuit for drive-controlling a shaft type linear motor for use in the component mounting device schematically shown in FIG. 1;

FIG. 9B is a graph showing the locus of a current value for detecting the origin of the driving shaft in the control circuit shown in FIG. 9A;

FIG. 9C is a view illustrating an example of detecting the origin of the driving shaft in the control circuit shown in FIG. 9A;

FIG. 9D is a view illustrating another example of detecting the origin of the driving shaft in the control circuit shown in FIG. 9A;

FIG. 10A is a view illustrating a mechanism for detecting the position of the driving shaft;

FIG. 10B shows an example of the output signal of each magnetic pole detection sensor shown in FIG. 10A;

FIG. 10C shows a configuration example of a period resolution table;

FIG. 10D is a view illustrating an inner cycle angle being used for the position detection of the driving shaft;

FIG. 11A is a view illustrating the position detection mechanism in the case that the axial center of the driving shaft is aligned with the center axis of the coils;

FIG. 11B shows examples of the output signals of the magnetic pole detection sensors shown in FIG. 11A;

FIG. 12A is a view illustrating the position detection mechanism in the case that the axial center of the driving shaft is moved in parallel with the center axis of the coils;

FIG. 12B shows examples of the output signals of the magnetic pole detection sensors shown in FIG. 12A;

FIG. 13A is a view illustrating the position detection mechanism in the case that the axial center of the driving shaft is moved in a direction intersecting the center axis of the coils;

FIG. 13B shows examples of the output signals of the magnetic pole detection sensors shown in FIG. 13A;

FIG. 14A is a front view showing a mounting head according to another aspect of the embodiment of the present invention;

FIG. 14B is a side view showing the mounting head shown in FIG. 14A;

FIG. 14C is a plan view showing the mounting head shown in FIG. 14A; and

FIG. 14D is a perspective view showing a magnetic force shielding member for use in the mounting head shown in FIG. 14A.

### BEST MODE FOR CARRYING OUT THE INVENTION

Before the description of the present invention proceeds, it is to be noted that like parts are designated by like reference numerals throughout the accompanying drawings.

A shaft type linear motor and a method for detecting the movement position of the drive shaft of the shaft type linear motor according to embodiments of the present invention will be described below by taking a component mounting device as an example referring to the drawings.

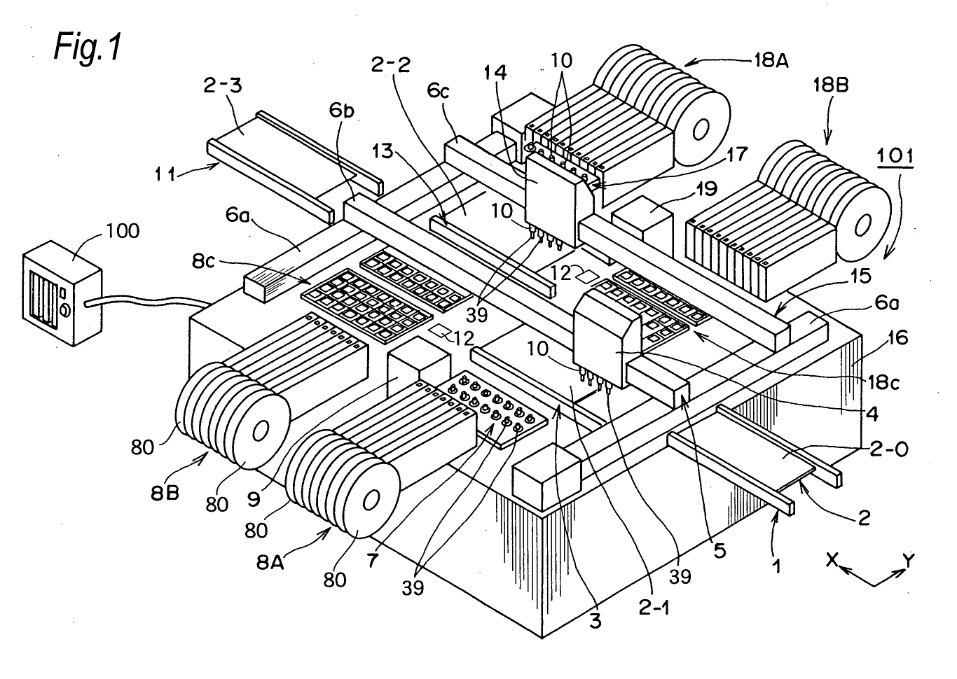

FIG. 1 is an overall schematic perspective view showing a component mounting device 101 according to an embodiment of the present invention. The component mounting device 101 comprises a loader 1 for loading circuit boards 2 into the component mounting device 101, an unloader 11 capable of unloading, from the component mounting device 101, circuit boards 2 on which components are mounted, and a first board transferring/holding device 3 provided with a pair of support rail sections to transfer and hold each of the circuit boards 2 loaded from the loader 1. FIG. 1 simultaneously shows a state in which a circuit board 2-0 placed on the loader 1 is being loaded into the component mounting device 101, a state in which components are being mounted on a circuit board 2-1 placed on the first board transferring/holding device 3, a state in which components are being mounted on a circuit board 2-2 placed on the second board transferring/holding device 13, and a state in which a circuit board 2-3 on which components have been mounted is being unloaded from the component mounting device 101 using the unloader 11. In the following descriptions, when a circuit board is mentioned generally regardless of the position thereof, the circuit board is referred to as “circuit board 2;” in addition, when a circuit board positioned at a specific position is mentioned, the circuit board is referred to as “circuit board 2-0, 2-1, 2-2, or 2-3.”

The component mounting device 101 further comprises component feeding sections 8A and 8B respectively disposed at the front end in the Y-axis direction in the figure in the component mounting area thereof, and having plural component feeding cassettes 80, each cassette being used to feed plural components to be mounted on the circuit board 2 to the component delivery position thereof continuously and sequentially; and a component feeding section 8C disposed near the component feeding section 8B and storing components to be mounted on the circuit board 2 in trays. The components fed from the component feeding cassettes 80 of the respective component feeding sections 8A and 8B are mainly very small chip components, for example; on the other hand, the components fed from the component feeding section 8C are mainly odd-shaped components, such as IC components typified by IC chips and connectors, for example.

In addition, the component mounting device 101 further comprises an installation section on which the component feeding sections 8A and 8B for feeding components are installed; a first mounting head 4 that sucks components fed from the component feeding sections 8A, 8B and 8C, and mounts them on the circuit board 2; a recognition camera 9, an example of an imaging device, disposed near the component feeding section 8A and on the side near the center of the component mounting area to take an image of the attitude of a component that is sucked and held using a nozzle section 39 provided at each of the tips of a suction nozzle assembly 10 in the first mounting head 4; and a mounting controller 100.

The first mounting head 4 is configured so as to be movable using an XY robot 5 that positions the head at predetermined positions in two orthogonal directions, i.e., the X-axis direction and the Y-axis direction, in the component mounting area on the upper face of the component mounting device 101. The first mounting head 4 is exchangeably provided with plural nozzle sections 39, for example, 12 nozzle sections, to releasably suck and hold components. The first mounting head 4 can be moved two-dimensionally in the component mounting area using the XY robot 5. For example, the first mounting head 4 can be moved to the component delivery positions of the component feeding sections 8A, 8B and 8C to suck and hold components fed from the component feeding sections 8A, 8B and 8C, respectively, to the positions opposed to the first transferring/holding device 3 to mount components on the circuit board 2-1 held on the first transferring/holding device 3, and to a position opposed to a nozzle station 7 so that the nozzle sections 39 provided for the mounting head 4 are exchanged as necessary. The nozzle station 7 is disposed in the component mounting area near the component feeding section 8A to accommodate plural kinds of nozzle sections 39 suited for plural kinds of components.

Furthermore, the component mounting device 101 shown in FIG. 1 comprises a second board transferring/holding device 13 provided with a pair of support rail sections to receive, transfer and hold the circuit board 2-1 transferred from the first board transferring/holding device 3; a second mounting head 14 removably provided with plural suction nozzle assemblies 10, for example, 12 nozzle assemblies, the nozzle assembly being an example of a component holding member for releasably sucking and holding components; an XY robot 15 for positioning the second head 14 at predetermined positions in the X-axis direction and the Y-axis direction; a nozzle station 17 disposed near the component feeding section 18A to accommodate plural kinds of nozzle sections 39 suited for plural kinds of components so that the nozzle sections 39 are exchanged with the nozzle sections 39 provided for the mounting head 14 as necessary; component feeding sections 18A and 18B respectively disposed at the rear end in the Y-axis direction in the figure, that is, on the rear side of the component mounting area with respect to the operator and having plural component feeding cassettes, each cassette being used to feed components to be mounted on the circuit board 2-1 to the component delivery position one by one continuously; a component feeding section 18C disposed near the component feeding section 18B and accommodating trays in which components to be mounted on the circuit board 2 are stored and held; and a recognition camera 19 disposed near the component feeding section 18A and on the side near the center of the component mounting area to take an image of the attitude of a component that is sucked using the nozzle section 39 of the second mounting head 14. Still further, load cells 12 that are used to measure loads at the time when the nozzle sections 39 of the first mounting head 4 and the second mounting head 14 make contact therewith and to adjust the heights of the nozzle sections 39 are provided at two locations inside the component mounting areas.

As described above, the component mounting device 101 has two component mounting areas disposed on the upper face of the mounting device base 16 thereof, whereby component mounting operations can be carried out for the circuit boards 2 respectively held on the first board transferring/holding device 3 and the second board transferring/holding device 13 using the first mounting head 4 and the second mounting head 14 simultaneously and independently.

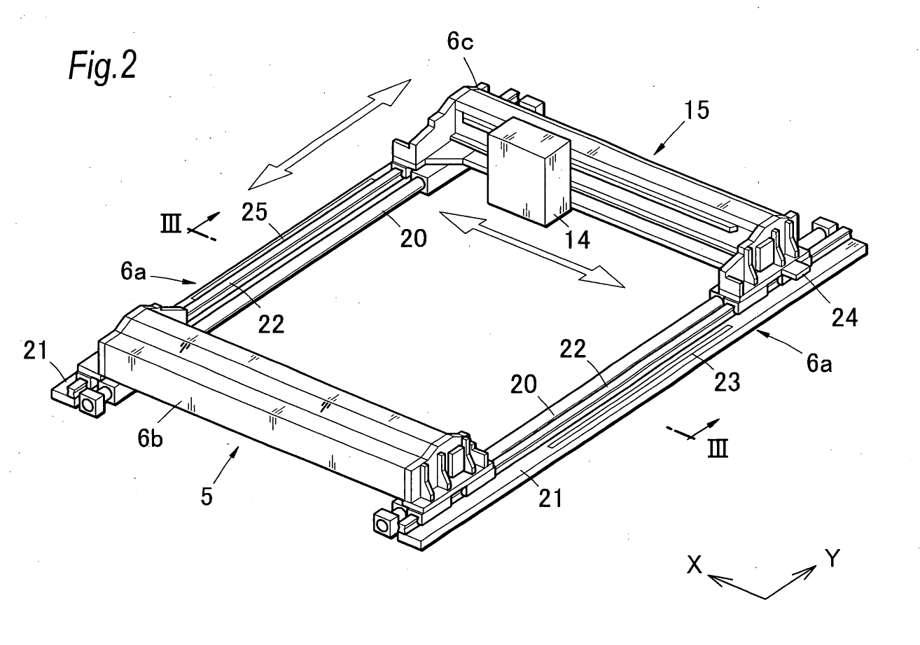

FIG. 2 is a schematic perspective view showing the XY robots 5 and 15 for use in the component mounting device shown in FIG. 1. As shown in FIG. 2, the XY robots 5 and 15 comprise a first X-axis section 6b for movably supporting the first mounting head 4 (not shown) in the X-axis direction in the figure and for driving the first mounting head 4 to move it in the X-axis direction; a second X-axis section 6c for movably supporting the second mounting head 14 in the X-axis direction in the figure and for driving the second mounting head 14 to move it in the X-axis direction; and Y-axis sections 6a disposed on the mounting device base 16 (see FIG. 1) and near both ends thereof in the X-axis direction to support the X-axis sections 6b and 6c at the ends thereof and to drive the X-axis drive sections 6b and 6c to move them in the Y-axis direction in the figure.

The Y-axis sections 6a can drive the two X-axis sections 6b and 6c to move them in the Y-axis direction independently to each other. In other words, the first mounting head 4 can be moved above the component mounting area on the front side in the figure in the X-axis direction or in the Y-axis direction using the X-axis section 6b and the Y-axis section 6a, independently of the second mounting head 14. On the other hand, the second mounting head 14 can be moved above the component mounting area on the rear side shown in the figure in the X-axis direction or in the Y-axis direction using the X-axis section 6c and the Y-axis section 6a, independently of the first mounting head 4. Furthermore, the X-axis sections 6b and 6c have limited movement ranges in the Y-axis direction and are thus prevented from colliding with each other when they are moved.

The XY robots 5 and 15 are configured so that they can move the first mounting head 4 and the second mounting head 14 in the X and Y directions using linear motors as drive sources. This configuration will be described later.

In addition, as shown in FIG. 1, the component mounting device 101 is provided with the mounting controller 100 capable of carrying out centralized control while the board loading/unloading, component holding, component recognition, component mounting, and other operations described above are related mutually. The mounting controller 100 is connected to the component feeding sections 8A, 8B, 18A and 18B, the component feeding cassettes 80, the first mounting head 4 and the second mounting head 14, the recognition cameras 9 and 19, the first board transferring/holding device 3, the second board transferring/holding device 13, the XY robots 5 and 15, the loader 1, the unloader 11, etc. Furthermore, the mounting controller 100 is provided with a database section and a memory section described and shown later. In this database section, component information library regarding shape, height, etc. depending on the kind of component, board information regarding shape and the like depending on the kind of circuit board, and information regarding the shape and position of the nozzle section 39 depending on the kind of component are stored beforehand so as to be readable. Besides, in the memory section, NC data serving as a mounting program instructing which component may be mounted at which position in which sequence; an arrangement program instructing which component may be arranged in which component feeder or arrangement information regarding the arrangement; information regarding the range in which component holding is possible, described later; and information regarding the board transfer position in each of the board transferring/holding devices are stored so as to be readable. In the mounting controller 100, various forms can be taken as to whether the above-mentioned respective information may be stored in the database section or the memory section, depending on the actual circumstances of component mounting to be performed.

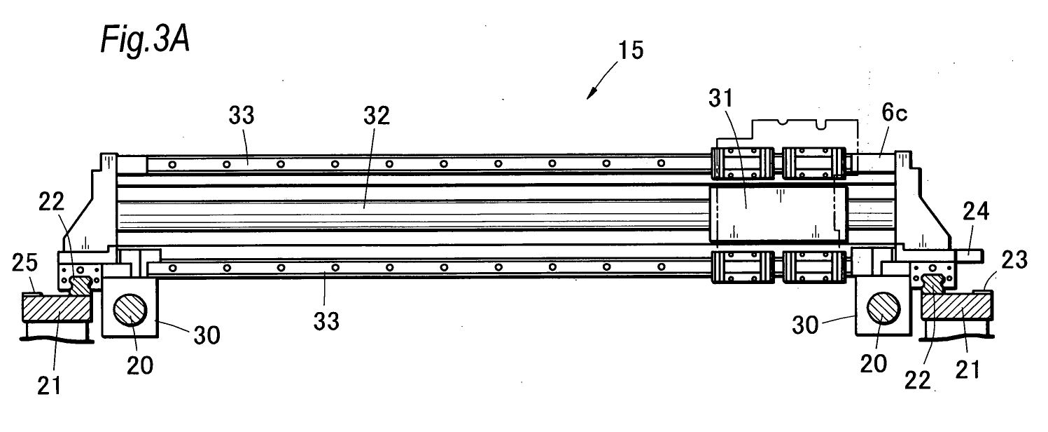

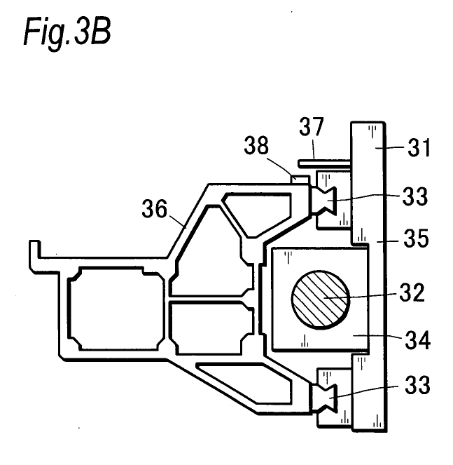

Next, the configurations of the XY robots 5 and 15 will be described referring to FIGS. 3A and 3B. The XY robots 5 and 15 are used to move the first mounting head 4 and the second mounting head 14 in the X and Y directions using linear motors as described above. FIG. 3A is a sectional view taken on line III-III of FIG. 2. FIG. 3B is a side view showing the X-axis section 6b shown in FIG. 3A. As shown in FIG. 3A, each of the Y-axis sections 6a (see FIG. 2) is formed of a Y-axis linear motor shaft 20 and a Y-axis guide beam 21 disposed in parallel and extending in the Y-axis direction. On the upper face of the Y-axis guide beam 21, a Y-axis linear guide 22, a first linear scale 25, and a second linear scale 23 are provided so as to extend in the Y-axis direction.

The Y-axis linear motor shafts 20 and the Y-axis guide beams 21 are installed on the mounting device base 16 and near both ends thereof in the X-axis direction as described above. Each Y-axis guide beam 21 is provided with the first linear scale 25 that is used to detect the position of the first X-axis section 6b and the second linear scale 23 that is used to detect the position of the second X-axis section 6c. The first linear scale 25 is provided so as to extend from the front end of the Y-axis guide beam 21 to the central portion thereof shown in FIG. 2; on the other hand, the second linear scale 23 is provided so as to extend from the rear end of the Y-axis guide beam 21 to the central portion thereof shown in FIG. 2. The first X-axis section 6b is provided with a first Y-axis position sensor 26 (not shown) disposed so as to be opposed to the first linear scale 25 on the left side of FIG. 2, and the second X-axis section 6c is provided with a second Y-axis position sensor 24 disposed so as to be opposed to the second linear scale 23 on the right side of FIG. 2. With the first and second linear scales 25 and 23 and the first and second Y-axis position sensors 26 and 24, the positions of the first and second X-axis sections 6b and 6c can be detected accurately.

The Y-axis linear motor shaft 20 of the Y-axis section 6a is provided with cylindrical permanent magnets disposed repeatedly so that the same poles thereof, the south magnetic poles or north magnetic poles, are opposed to each other. The two Y-axis linear motor shafts 20 are inserted into Y-axis movable sections 30 provided at both ends of the first X-axis section 6b and the second X-axis section 6c, thereby holding the first X-axis section 6b and the second X-axis section 6c so as to be movable in the Y-axis direction. An electric magnet formed of a coil is disposed in each of the Y-axis movable sections 30 provided at both ends of the first X-axis section 6b and the second X-axis section 6c. The electric magnets have magnetism by passing a drive current through the coils and function as linear motors.

The drive current is supplied to the coils disposed in the Y-axis movable sections 30 at both X-axis direction ends of the first X-axis section 6b simultaneously from the above-mentioned mounting controller 100; furthermore, the drive current is supplied to the coils disposed in the Y-axis movable sections 30 at both X-axis direction ends of the second X-axis section 6c simultaneously from the above-mentioned mounting controller 100. Hence, the Y-axis movable sections provided at both ends of the first X-axis section 6b and the second X-axis section 6c have magnetism in complete synchronization with each other, thereby capable of moving the Y-axis sections 6a independently.

With the above-mentioned configuration in which the linear motors are used to drive the first X-axis section 6b and the second X-axis section 6c and the coils serving as drive sources are disposed at both ends, the wobbling of the mounting head due to the vibration of the first X-axis section 6b and the second X-axis section 6c can be reduced, and an adverse effect on component mounting can be reduced; furthermore, since the drive current can be supplied from one control driver to both ends of the two X-axis sections 6b and 6c simultaneously, the actions of the drive mechanisms at both ends of the two X-axis sections 6b and 6c can be in nearly complete synchronization with each other, and the first X-axis section 6b and the second X-axis section 6c can be moved while they are maintained in nearly complete parallel with the X-axis.

The first X-axis section 6b and the second X-axis section 6c are nearly identical in configuration, except that the mounting head moving sections 31 thereof on which the mounting heads are installed are disposed so as to be opposed to each other. The second X-axis section 6c is taken as an example and described below referring to FIGS. 3A and 3B. As shown in FIG. 3B, in the second X-axis section 6c, an X-axis frame 36, the outer shape of which has a nearly Y-shaped cross-section, is provided with an X-axis linear motor shaft 32 and X-axis linear guides 33 at two positions in the vertical direction. The X-axis linear motor shaft 32 is inserted into the X-axis moving section 34 of the mooting head moving section 31 to establish engagement therebetween. The mounting head moving section 31 is configured so as to be movable in the X-axis direction along the two X-axis linear guides 33. The X-axis frame 36 is provided with an X-axis linear scale 38, and the scale is configured so that the position of the mounting head moving section 31 can be detected using an X-axis position sensor 37 provided on the mounting head moving section 31.

The X-axis linear motor shaft 32 is provided with cylindrical permanent magnets disposed repeatedly so that the same poles thereof, the south magnetic poles or north magnetic poles, are opposed to each other. The X-axis moving section 34 is provided with an electric magnet formed of a coil. The electric magnet has magnetism by passing a drive current through the coil and functions as a linear motor.

The drive current is supplied from the above-mentioned mounting controller 100 to the coil disposed in the X-axis moving section 34. Hence, the mounting head moving section 31 is moved by the magnetism generated in the X-axis moving section 34 along the X-axis linear motor shaft 32.

The mounting head moving section 31 has an installation face 35 to which the first mounting head 4 or the second mounting head 14 is secured.

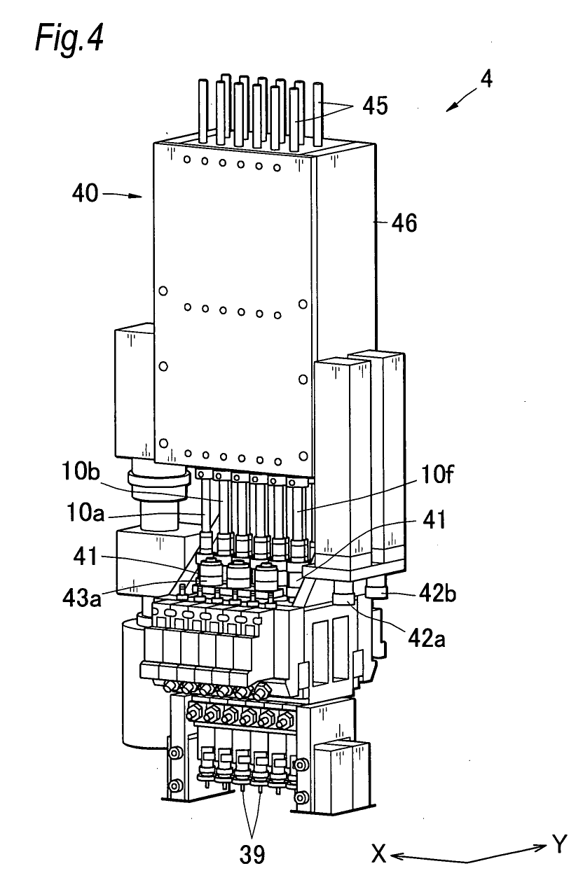

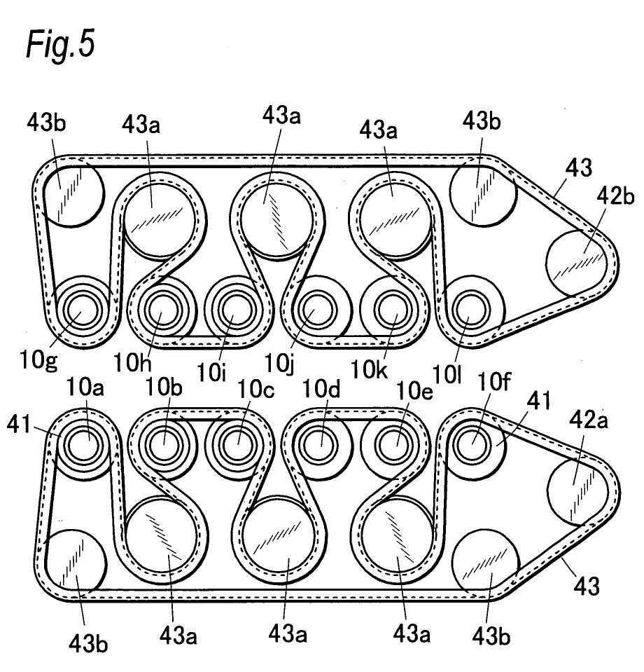

Next, the structures of the mounting heads 4 and 14 will be described in detail referring to the drawings. Since the first mounting head 4 and the second mounting head 14 have similar structures, the structure of the first mounting head 4 is taken as a representative and described below. FIG. 4 is an overall view showing the mounting head 4, and FIGS. 5 to 8 are fragmentary detailed views thereof.

In FIG. 4, the first mounting head 4 is configured as a so-called multi-shaft mounting head provided with plural suction nozzle assemblies, for example, 12 nozzle assemblies 10a to 10l, wherein the suction nozzle assemblies are arranged in six rows at a constant pitch Px in the X-axis direction in the figure and also arranged in two rows at a constant pitch Py in the Y-axis direction in the figure. The suction nozzle assemblies 10 provided for the first mounting head 4 are referred to as a first suction nozzle assembly 10a, a second suction nozzle assembly 10b, a third suction nozzle assembly 10c, a fourth suction nozzle assembly 10d, a fifth suction nozzle assembly 10e, and a sixth suction nozzle assembly 10f in the order from the left to the right in the figure, on the front side in the Y-axis direction in the figure, and further referred to as a seventh suction nozzle assembly 10g (the reference numerals of this and subsequent suction nozzle assemblies are not shown in the figure), an eighth suction nozzle assembly 10h, a ninth suction nozzle assembly 10i, a 10th suction nozzle assembly 10j, an 11th suction nozzle assembly 10k, and a 12th suction nozzle assembly 10l in the order from the left to the right in the figure, on the rear side in the Y-axis direction in the figure. In addition, plural component feeding cassettes 80 are arranged in the component feeding section 8A (or 8B; see FIG. 1) at a constant pitch L in the X-axis direction in the figure. Furthermore, the constant pitch Px of the suction nozzle assemblies 10 arranged in row may only be an integral plural of the constant pitch L of the component feeding cassettes 80 arranged in row (Px=L×n); in this embodiment, the pitch Px is equal to the pitch L (n=1).

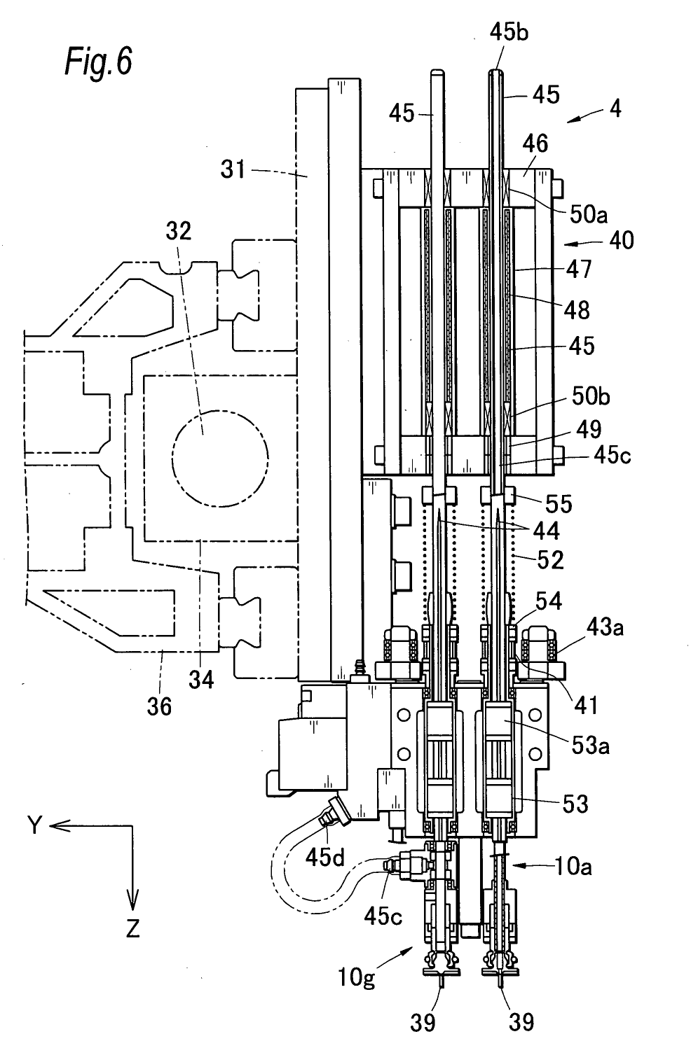

The first to 12th suction nozzle assemblies 10a to 10l are nearly identical in structure, each being movable in the Z-axis direction in the figure and held so as to be rotatable around the center of the axis thereof using a housing 46 provided in the upper portion of the first mounting head 4 and an outer cylinder 53 (see FIG. 6) having a ball spline nut 53a. The suction nozzle assembly 10 is configured so as to be movable vertically in the axial direction (the Z-axis direction) using an actuator 40 provided inside the housing 46 as described later and is provided with a spline shaft 44 so as to be able to carry out θ-rotation, a rotation around the axis thereof.

In FIG. 6, each of the suction nozzle assemblies 10 (only the first suction nozzle assembly 10a and the seventh suction nozzle assembly 10g, disposed on the most front side, are shown In FIG. 6, and the others are disposed behind) comprises the spline shaft 44, the nozzle section 39 provided at the lower end of the spline shaft 44, a driving shaft 45 being coaxially integrated with the spline shaft 44, and a timing pulley 41 for θ-rotating the suction nozzle assembly 10.

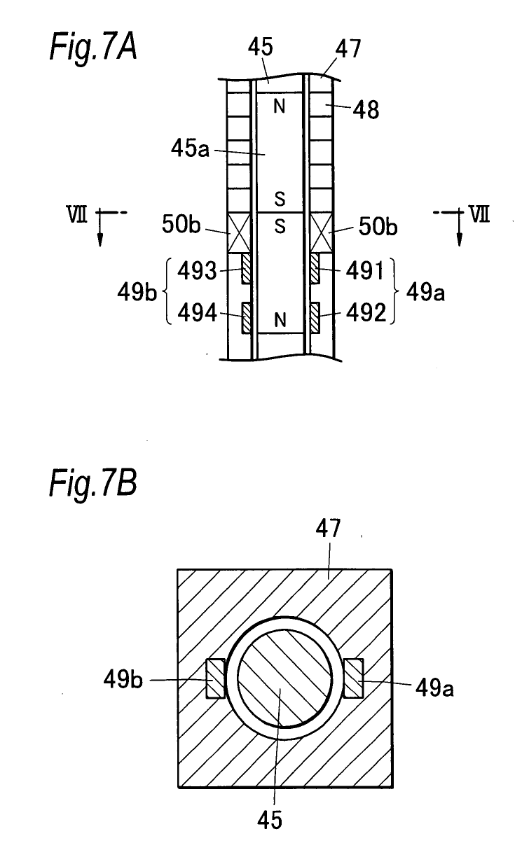

The driving shaft 45 operates as the drive shaft of the actuator 40 for moving the suction nozzle assembly 10 vertically. As described above, in this embodiment, the driving shaft 45 is formed in a shaft shape in which plural cylindrical permanent magnets, each having magnetic poles at both ends thereof in the axial direction, are disposed and secured coaxially so that the same poles are opposed to each other (see FIG. 7A). The timing pulley 41 is connected to the spline shaft 44, and these two are movable relatively in the Z-axis direction, but the relative movement of these in the rotation direction around the Z-axis is limited. FIG. 5 is a view, from above, showing the relationship among the suction nozzle assemblies 10, the timing pulleys 41, and the timing belts 43. One timing belt 43 is engaged with the timing pulleys 41 of the first to sixth suction nozzle assemblies 10a to 10f. The timing belt 43 is engaged via five tension pulleys 43a and 43b so as to be completely engaged with the six suction nozzle assemblies 10a to 10f. By virtue of the engagement of the timing belt 43, the forward/reverse rotation drive of a θ-rotation motor 42a is transmitted via the timing belt 43, thereby being capable of carrying out θ-rotation for the first to sixth suction nozzle assemblies 10a to 10f simultaneously (the rotation of the suction nozzle assemblies 10 around the axis thereof).

Similarly, another timing belt 43 is engaged with the timing pulleys 41 of the seventh to 12th suction nozzle assemblies 10g to 10l; hence, the forward/reverse rotation drive of the other θ-rotation motor 42b is transmitted via the timing belt 43, thereby being capable of carrying out θ-rotation for the seventh to 12th suction nozzle assemblies 10g to 10l simultaneously.

Returning to FIG. 6, the actuator 40 is formed of a shaft type linear motor (hereafter designated by reference numeral 40); the shaft type linear motor 40 vertically moves the corresponding suction nozzle 39, whereby component suction and holding or component mounting can be carried out selectively. The actual configuration of the shaft type linear motor 40 will be described later. This embodiment is configured so that the drive power of one of the θ-rotation motors, that is, the θ-rotation motor 42a, is transmitted via the timing belt 43 to θ-rotate the first to sixth suction nozzle assemblies 10a to 10f and so that the drive power of the other θ-rotation motor 42b is transmitted via the timing belt 43 to θ-rotate the seventh to 12th suction nozzle assemblies 10g to 10l; however, this kind of configuration is taken just as an example; this embodiment may also be configured so that the vertical movement and the θ-rotation of the suction nozzle assemblies 10 can be carried out using only one actuator 40 and one θ-rotation motor 42, respectively and so that the plural suction nozzle assemblies 10 are driven selectively.

In addition, each of the component feeding cassettes 80 accommodates plural components so that the components can be delivered and is provided with a component delivery position in which the components are disposed so as to be able to be delivered. Furthermore, the component delivery positions are arranged in a row at the constant pitch L in the X-axis direction in the figure as described above. Since the component delivery positions are disposed as described above, the nozzle sections 39 arranged in the X-axis direction can be disposed above the component feeding cassettes 80 arranged in the X-axis direction, for example, the first suction nozzle assembly 10a is disposed above the component delivery position of the first component feeding cassette 80, and the second suction nozzle assembly 10b is disposed above the component delivery position of the second component feeding cassette 80, simultaneously, whereby component suction, holding, and delivery from the component discharging positions using the suction nozzle assemblies 10 can be carried out simultaneously.

Next, the shaft type linear motor 40 serving as an actuator for the mounting heads 4 and 14 will be described below referring to the drawings. In FIG. 6, the shaft type linear motor 40 comprises the driving shaft 45 configured so as to be coaxial with the spline shaft 44 of the suction nozzle assembly 10, a the stator 47 provided inside the housing 46 of the mounting head 4 and equipped with coils 48 and a position-detecting magnetic pole sensor 49. The driving shaft 45 is formed of plural cylindrical magnets secured so that the same poles thereof, the south magnetic poles or the north magnetic poles, are made contact with and opposed to each other in the axial direction (see FIG. 7A), and an air suction hole is formed in the hollow portion thereof. The driving shafts 45 of the seventh to 12th suction nozzle assemblies 10g to 10l according to this embodiment are not configured hollow up to both ends as described later. However, the driving shafts are similar in the configuration in which plural magnets are secured so that the same poles are made contact with each other in the axial direction.

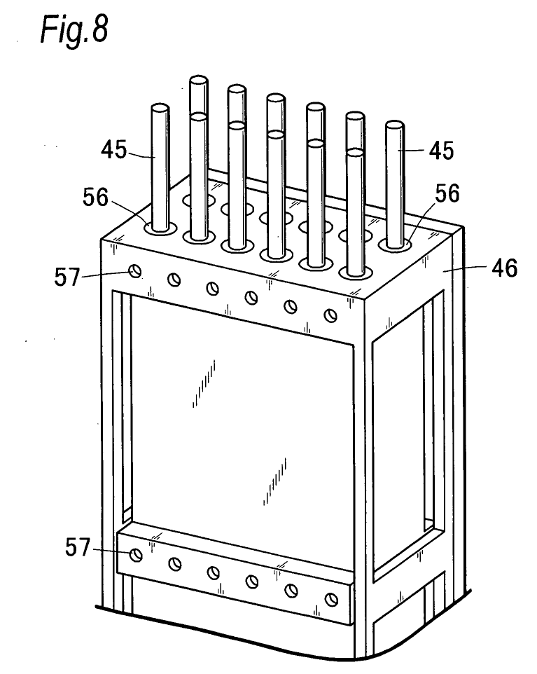

As shown in FIG. 8, the housing 46 has a hollow rectangular shape with a sufficient wall thickness to provide mechanical strength and made of a nonmagnetic material, such as a plastic, aluminum, or ceramic material. The housing 46 has through holes 56 on the upper face thereof, the diameter of which is slightly larger than that of the driving shaft 45 so as to movably accommodate the driving shaft 45. The through hole 56 is aligned so as to communicate with the hollow holes formed in the coils of the stator 47 disposed in the housing 46 as described later. Female threads 57 are formed on the side face of the housing 46 so that the housing is secured to the installation face 35 of the mounting head moving section 31 using screws.

The driving shafts 45 secured to the first to sixth suction nozzle assemblies 10a to 10f (the right side row of the suction nozzle assemblies corresponding to the right side one of the two suction nozzle assemblies shown in FIG. 6) are configured so as to be hollow as described above; air is sucked from a suction connection port 45b provided at the upper end thereof, whereby suction air can be passed to the nozzle section 39 provided at the tip of the driving shaft 45 via the hollow hole 45e. Furthermore, the driving shafts 45 secured to the seventh to 12th suction nozzle assemblies 10g to 10l (the left side row of the suction nozzle assemblies corresponding to the left one of the two suction nozzle assemblies shown in FIG. 6) are configured so as to be solid, and an air suction port 45c is formed in the spline shaft 44. The suction port 45c is connected to a suction connection nozzle 45d provided on the outer cylinder 53, and air inside the spline shaft 44 is sucked, whereby suction air can be passed to the nozzle section 39 provided at the tip of the spline shaft 44.

Next, in FIG. 7A, plural driving permanent magnets 45a constituting the driving shaft 45 are hollow cylindrical permanent magnets having nearly identical lengths, and both ends thereof in the axial direction are magnetized in the south and north magnetic poles. In the driving shaft 45, the driving permanent magnets 45a are stacked concentrically in the axial direction so that the same poles thereof, the south magnetic poles or the north magnetic poles, are opposed to each other. The magnetic poles provided for the driving shaft 45 may be configured so that plural cylindrical magnets having a uniform length are incorporated into a rod-shaped core material, for example, or so that sheet-like permanent magnets are disposed so as to externally cover the outer circumferential face of a rod-shaped core material. Furthermore, the driving shaft may be magnetized directly.

The stator 47 is formed of plural ring-shaped coils 48, provided with a circular hole at the center into which the driving shaft 45 is insertable, and disposed so as to be stacked in the Z-axis direction so that the holes are concentric; the holes of the respective coils 48 are formed as insertion holes into which the driving shaft 45 is inserted. When the driving shaft 45 is accommodated in the insertion holes, the coils 48 are positioned inside the stator 47 so as to be opposed to the permanent magnets 45a of the driving shaft 45. More specifically, each coil is wound so as to surround the driving permanent magnet 45a along the outer circumferential face thereof and wound into loop around a member having a core portion for coil winding, whereby the coils are installed inside the stator 47 so as to be opposed to the driving permanent magnets 45a. A protective film, such as a polytetrafluoroethylene film, is attached to the outer face of the coil 48 to prevent contact between the coils 48 and the driving permanent magnets 45a. As described above, it is preferable that the coils 48 may be disposed along the curved outer circumferential faces of the driving permanent magnets 45a to minimize the loss of lines of magnetic force.

Bearings 50a and 50b (see FIG. 6) are provided above and below the stacked coils 48 to guide the driving shaft 45 so that the driving shaft is not deviated from the axial center of the stacked coils 48 and to hold the driving shaft 45 so that the driving shaft can move in the axial direction thereof. The position-detecting magnetic pole sensor 49 is disposed further below the lower bearing 50b as shown in the figure. As shown in FIGS. 7A and 7B, the position-detecting magnetic pole sensor 49 is provided with two sensor units 49a and 49b, comprising two magnetic pole detection sensors 491 and 492 and two magnetic pole detection sensors 493 and 494, respectively, the two magnetic pole detection sensors being disposed so as to be arranged in the axial direction. The magnetic pole detection sensors 491 to 494 for use in the two sensor units 49a and 49b shown in the two figures detect the magnetic field intensity of the driving permanent magnets 45a depending on the position of the driving shaft 45. In this embodiment, the driving permanent magnet 45a is made of permalloy, and the sensor is formed of an MR sensor (magnetoresistance sensor), the electrical resistance of which changes owing to the magnetoresistance effect when a magnetic field is applied, and a constant current is passed in the sensor. While the current is passed in the MR sensor, the change in the voltage is measured, whereby the change in the magnetic field is detected; hence, the position of the driving shaft 45 with respect to the stator 47 can be detected.

As shown in the plan view of FIG. 7B, the sensor units 49a and 49b are disposed so as to be axially symmetrical around nearly the same circumference while the driving shaft 45 is used as the axial center. Furthermore, as shown in FIG. 7A, the two magnetic pole detection sensors 491 and 492 and the two magnetic pole detection sensors 493 and 494, respectively constituting the sensor units 49a and 49b, are disposed with a clearance therebetween being approximately equal to half of the axial-direction dimension of one of the permanent magnets 45a constituting the driving shaft 45. As a result, in the state shown in FIG. 7A, when either the magnetic pole detection sensor 492 or the magnetic pole detection sensor 494 detects a approximately maximum magnetic field intensity (in other words, when the sensor is positioned so as to be opposed to the tip of one of the driving permanent magnets 45a in the axial direction), the other magnetic pole detection sensor 491 or 493 can detect approximately zero magnetic field intensity (in other words, the axial center position of one of the driving permanent magnets 45a). The position detection of the driving shaft 45 and the detection method using the sensor units 49a and 49b will be described later.

Returning to FIG. 6 again, each suction nozzle assembly 10 is configured so as to be movable vertically in the Z-axis direction using the shaft type linear motor 40; on the other hand, the suction nozzle assembly 10 is held in a state of being energized upward in the figure using a spring 52 so as not to be lowered by gravity. More specifically, between a spring seat 54 provided on the side of the outer cylinder 53 having the ball spline nut 53a for receiving the spline shaft 44 of the suction nozzle assembly 10 and a spring seat 55 secured to the driving shaft 45 that is integrated with the spline shaft 44, the spring 52 having a natural length larger than the distance between the two spring seats 54 and 55 is disposed coaxially with the driving shaft 45, whereby the driving shaft 45 is energized upward in the figure so that the suction nozzle assembly 10 does not drop by gravity. When the driving shaft is positioned at its origin position, the spring seat 55 makes contact with the lower end of the stator 47, thereby functioning as a stopper for preventing the driving shaft from rising further. A method for detecting the origin of the driving shaft using this function will be described later.

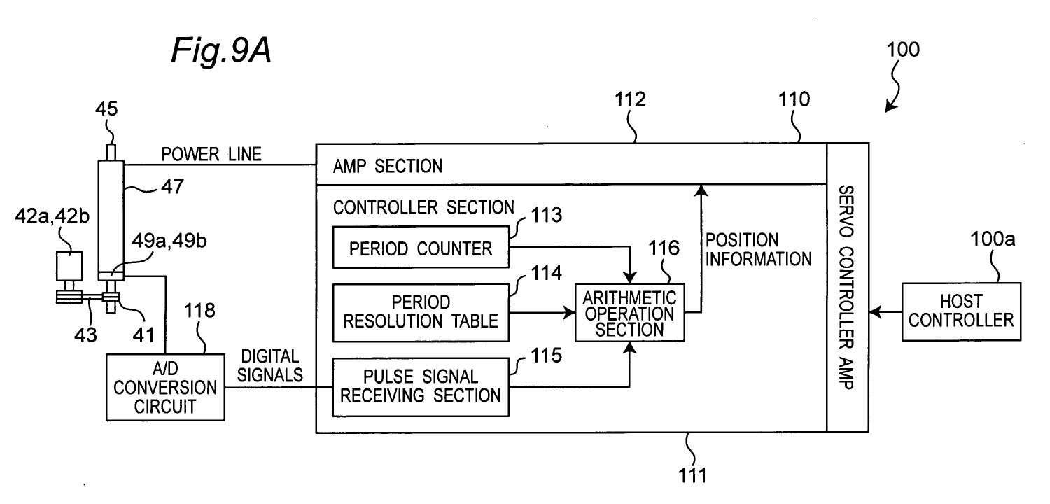

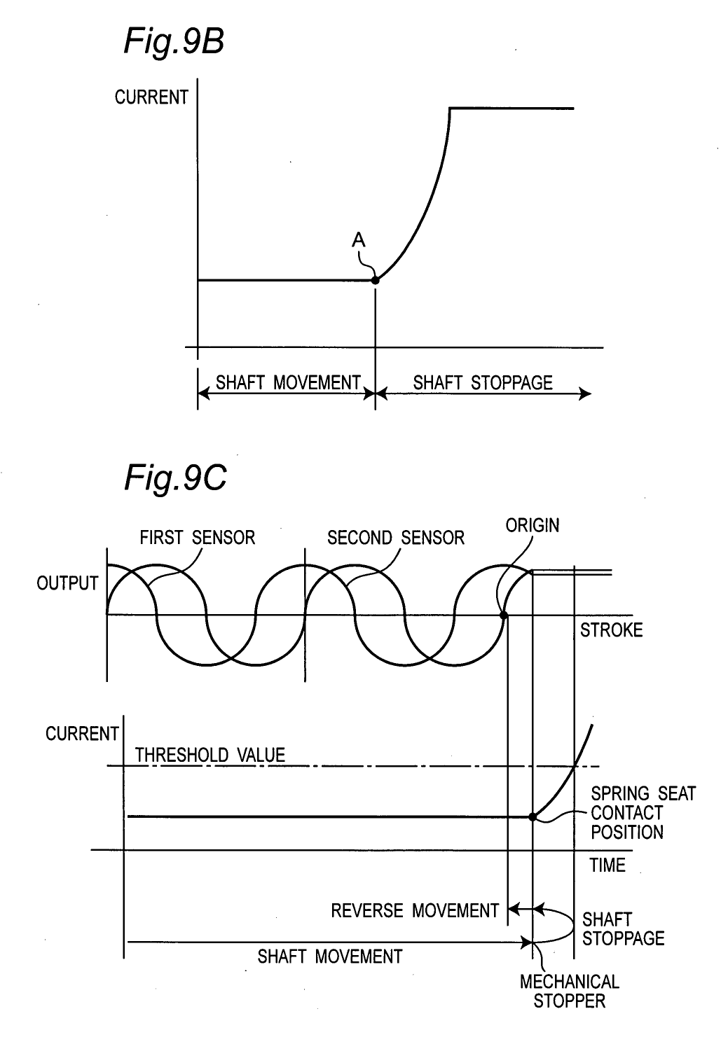

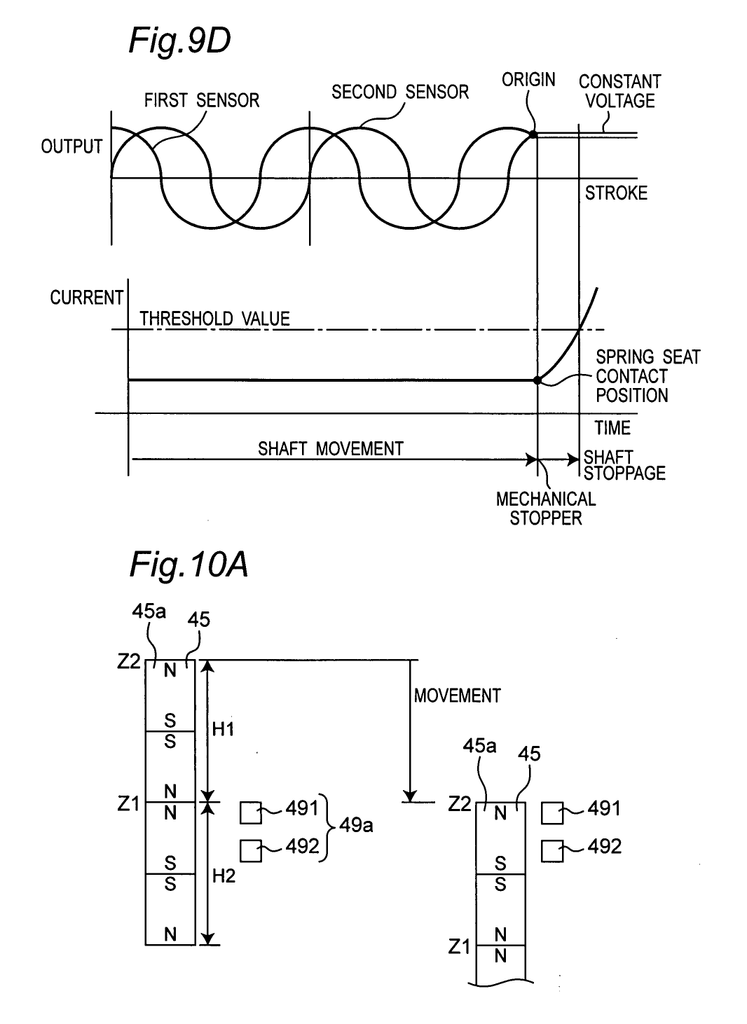

Next, means for detecting and controlling the movement position of the driving shaft 45 that is moved by driving the shaft type linear motor 40 will be described referring to FIGS. 9 to 13. FIG. 9A is a block diagram showing a control circuit for drive-controlling the shaft type linear motor 40 and for detecting the position thereof. In the figure, a servo controller servo amp 110 for drive-controlling the shaft type linear motor 40 forms a part of the mounting controller 100 and comprises an amp section 112 and a controller section 111. The amp section 112, for example, receives operation command signals input from a host controller 100a inside the mounting controller 100 and supplies electric power to the coils of the stator 47 via a power line. A current flows in the coils 48 by virtue of the drive current output from the amp section 112 of the servo controller servo amp 110, and a repulsive force is exerted between the coils 48 and the north or south magnetic pole of the driving permanent magnet 45a, whereby the driving shaft 45 is moved in the Z-axis direction to a predetermined position along the stator 47.

The controller section 111 of the servo controller servo amp 110 comprises a period counter 113, a period resolution table 114, a pulse signal receiving section 115, and an arithmetic operation section 116. In order to detect at which position of the drive period the driving shaft 45 is located, the period counter 113 divides a magnetic period described later into plural pulses (1000 pulses are used in this embodiment for the sake of explanatory convenience; however, in actual practice, the number of pulses may be a power of two, for example, 1024, so as to be subjected to computer processing), and counts the drive pulses of each period counter. The period resolution table 114 stores data regarding the period length of the magnetic field provided for the driving shaft 45, and is used for correcting position detection on the basis of the fact that the periods of the magnetic field provided for the drive period are not completely the same.

As the driving shaft 45 is moved along the stator 47, the driving permanent magnets 45a constituting the driving shaft 45 pass through the positions opposed to the magnetic pole detection sensors 491 to 494 of the sensor units 49a and 49b provided for the stator 47 (see FIG. 7A). As described above, when it is assumed that the length of the driving permanent magnet 45a in the Z-axis direction is 4 mm, for example, the north and south magnetic poles are formed at an interval of 4 mm; hence, the magnetic period is 8 mm, that is, the length of the two magnets. As the driving shaft 45 is moved, the relative position between the magnetic pole detection sensors 491 to 494 and the respective permanent magnets 45a is changed, and the resistance values of the magnetic pole detection sensors 491 to 494 are changed.

Attention is now paid to one of the sensor units, i.e., the sensor unit 49a (see FIG. 7A) (the explanation is similarly applicable to the other sensor unit 49b). Since a constant current flows in the magnetic pole detection sensors 491 and 492 constituting the sensor unit 49a, when the driving permanent magnet 45a is moved, magnetic field intensity signals are output from the respective magnetic pole detection sensors 491 and 492 depending on the magnetic field intensity of the magnetic period, and then input to an A/D conversion circuit 118. The magnetic field intensity signal output from each of the magnetic pole detection sensors 491 and 492 has a nearly sine waveform locus, just like the magnetic field intensity of the magnetic period. The A/D conversion circuit 118 A/D-converts and amplifies the magnetic field intensity signal, and then inputs the obtained signal to the pulse signal receiving section 115 of the controller section 111. The pulse signal receiving section 115 shapes the waveform of the digital signal being input continuously, generates a predetermined digital signal, and outputs the digital signal to the arithmetic operation section 116. The arithmetic operation section 116 detects the origin of the driving shaft 45 and calculates the position thereof as described below on the basis of the value of the digital signal having been input and shaped in waveform.

First, the method for detecting the origin position will be described. This embodiment uses the fact that the current value applied to the coils 48 is changed when the driving shaft 45 is moved upward and when the spring seat 55 makes contact with the lower end of the stator 47; the current value is detected to detect the origin. In other words, as shown in FIG. 9B, the driving shaft 45 is moved upward, and the spring seat 55 makes contact with the lower end of the stator 47 at point A in the figure, whereby the driving shaft 45 cannot be moved upward further. At this time, since the driving shaft 45 is attempted to be moved although the driving shaft cannot be moved, the current value applied to the coil 48 begins to increase abruptly at point A as shown in FIG. 9B.

The servo controller servo amp 110 detects the origin position on the basis of the position of the driving shaft 45 located at the time when the current value began to increase and then exceeded a threshold value, and detects the position of the driving shaft 45 by using the above-mentioned position as the reference position as described later. Since the driving shaft 45 is stopped at this time, the output values being output from the respective magnetic pole detection sensors are constant; hence, more stable detection is made possible by additionally including this matter into the origin position detection conditions.

In this embodiment, as shown in FIG. 9C, when it is detected that the current value exceeded the threshold value and that the outputs of the two magnetic pole detection sensors 491 and 492 remain unchanged because the driving shaft 45 was moved upward and because the spring seat 55 made contact with the lower end of the stator 47, control is carried out to move the driving shaft 45 downward from the position. Then, the position at which the output of one of the magnetic pole detection sensors 491 and 492 (in the figure, the sensor is designated by a first or second magnetic pole detection sensor because it is not necessary to differentiate between the two sensors) becomes zero for the first time is determined to be the origin.

In addition, as an alternative method for determining the origin position, as shown in FIG. 9D, the position at which the driving shaft 45 is located when the driving shaft 45 was moved upward and the spring seat 55 made contact with the lower end of the stator 47, that is, when the current value applied to the coils 48 increased and exceeded the threshold value, is directly used as the origin. The origin position obtained in this case does not necessarily coincide with a specific position, such as a position at which the magnetic field intensity output from the magnetic pole detection sensor 491 or 492, represented using a sine curve, becomes zero; hence, the origin is determined at a given position on the curve, other than such a specific position.

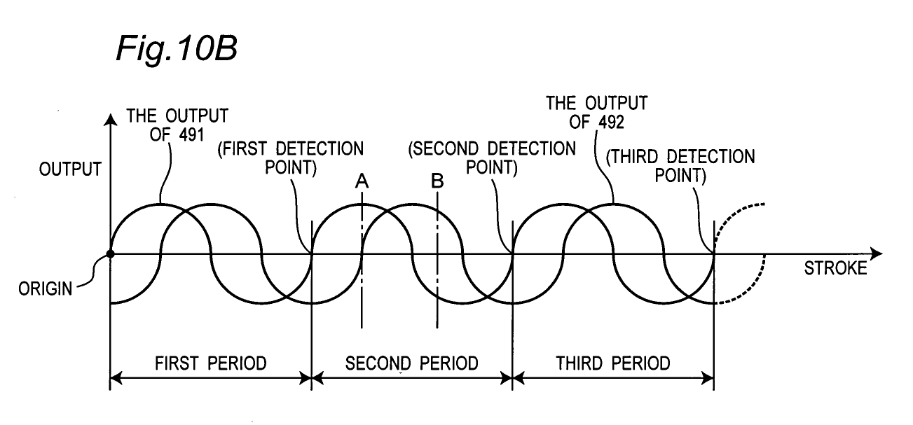

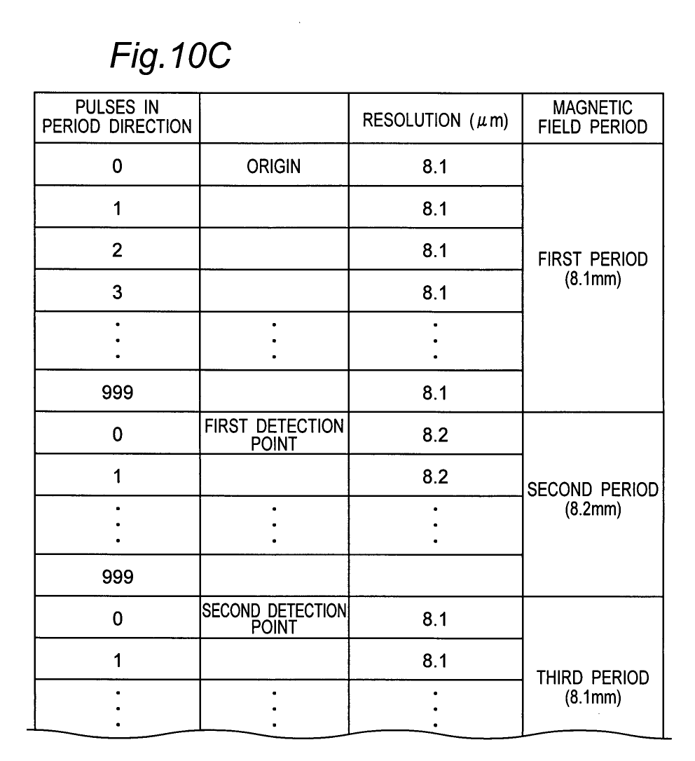

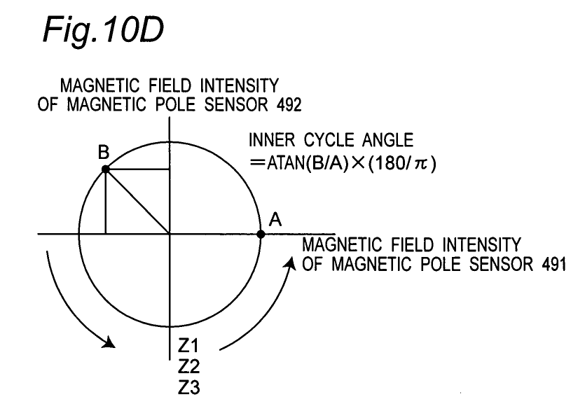

Next, an example of actual detection calculation for detecting the position of the driving shaft 45 will be described referring to FIG. 10A. In FIG. 10A, when it is assumed that the length of each of the driving permanent magnets 45a constituting the driving shaft 45 in the Z-axis direction is 4 mm, the distance H between the north poles is 8 mm. When it is assumed that the driving shaft 45 has moved downward in the Z-axis direction as indicated by the arrow shown in FIG. 10A, the two magnetic pole detection sensors 491 and 492 output their magnetic field intensity values as voltages (in the output range of −5 to +5 V in this embodiment), and the output signals become magnetic field intensity signals having such nearly sine waveforms as shown in FIG. 10B. In this embodiment, since the two magnetic pole detection sensors 491 and 492 are disposed with a clearance therebetween being approximately equal to half of the Z-axis direction length of the permanent magnet 45a, that is, 2 mm, the phases of the sine waveforms representing the magnetic field intensity signals having been output are shifted by π/2 from each other.

When it is herein assumed that the measurement resolution of the voltage value (in the direction of the vertical axis in FIG. 10B) of the A/D conversion circuit 118 for converting the magnetic field intensity signals output from the two magnetic pole detection sensors 491 and 492 into digital signals is ±500 and that the measurement resolution in the magnetic period direction (in the direction of the horizontal axis in FIG. 10B) is 1000, the resolution of the detection accuracy is 8 mm/1000=8 μm.

The magnetic field intensity signals output from the two magnetic pole detection sensors 491 and 492 will be described herein referring to FIG. 10B. For the purpose of detecting the position of the driving shaft 45, the position of the driving shaft 45 is detected on the basis of the movement distance from the origin. In other words, as described above, the driving shaft 45 is moved to the origin that is detected by detecting the current value applied to the coils 48 and then moved downward in the Z-axis direction. At this time, the points at which the same output values as the output values of the magnetic pole detection sensors 491 and 492 at the origin position are obtained (the positions at which the output of the sensor 491 is zero and the output of the sensor 492 is maximum) are respectively recognized as the detection points, and the detection points are referred to as a first detection point, a second detection point, . . . in the order in which the points are closer to the origin. The period between the origin and each detection point is determined as one magnetic period.

The period resolution table 114 stores information regarding resolution for the number of pulses in the period direction for respective periods as shown in FIG. 10C. Since the resolution in the magnetic period direction is set to 1000 as described above in this embodiment, the value obtained by dividing one period, that is, the total length of two magnets, by 1000 becomes one pulse resolution. Furthermore, although the driving permanent magnets 45a constituting the driving shaft 45 are configured so as to be almost the same in length in the Z-axis direction, the length may vary depending on conditions during machining, thereby causing variations in the magnetic period. The variations are added cumulatively as the position is farther from the origin, and the accuracy of the position detection at positions far away from the origin is lowered. For the purpose of correcting the variations in the length of the period, the information regarding the period lengths for magnetic periods is stored in the resolution table 114. This is obtained by measuring beforehand the lengths of the driving permanent magnets 45a that are stacked in the axial direction. The example shown in FIG. 10C indicates a case in which the period length of the first period is 8.1 mm and one pulse resolution is 8.1 μm, and another case in which the period length of the second period is 8.2 mm and one pulse resolution is 8.2 μm.

Herein, a case is examined in which the respective output values of the magnetic pole detection sensors 491 and 492 were the outputs obtained at point B shown in FIG. 10B (for example, the output of the magnetic pole detection sensor 491 was −2 V, and the output of the magnetic pole detection sensor 492 was +2 V). Since point B has passed the first detection point as viewed from the origin, it is found that point B is located in the second period. Furthermore, since the inner cycle angle ATTN is (2/−2)×(180/π)=−45 degrees and the output of the magnetic pole detection sensor 491 was negative, point B becomes 180−45=135 degrees. Hence, point Z1 is located at 270 degrees (−90 degrees as viewed from point A) according to the waveform of the above-mentioned magnetic pole detection sensor, and the rotation starts counterclockwise from the point; hence, the detection position becomes the period length of the second period 8.2 mm×(225 degrees/360 degrees)=5.125 mm; this means that the shaft has moved 5.125 mm from the start position of the second period, that is, the first detection point. The above-mentioned 225 degrees is obtained by the above-mentioned 135 degrees+90 degrees.

Furthermore, since the driving shaft 45 has moved beyond one period, the first period length (the length of two driving permanent magnets), 8.1 mm, is added to the distance based on the first detection point. As a result, the movement distance from the origin is output as 13.225 mm.

The period lengths of the magnetic field to be added at the time of calculating the movement distance may be calculated uniformly as the length of two driving permanent magnets, instead of being stored beforehand as table data as described above.

Since each of the driving shafts 45 of the mounting heads 4 and 14 is guided using the bearings 50a and 50b provided above and below the coils 48 so that the axis of the shaft is aligned with the center axis of the coils 48 as described above, the driving shaft 45 is prevented from being deviated in the X-axis direction and in the Y-axis direction inside the stator 47. Hence, even when the suction nozzle assembly 10 is rotated around its axis using the θ-rotation motor 42a, the clearance between the sensor unit 49a and the driving permanent magnets 45a constituting the driving shaft 45 is maintained nearly constant. Under these conditions, the movement distance of the driving shaft 45 can be detected using the one sensor unit 49a having the two magnetic pole detection sensors 491 and 492 as described above.

However, it may be conceivable that the axial center of the driving shaft 45 is deviated from the center axis of the coils 48 or inclined with respect to the axis owing to factors, such as permanent set in fatigue caused in the bearings 50a and 50b, and backlash occurred in other mechanical components. Even in such a case, the position of the driving shaft 45 can be detected accurately using the two sensor units 49a and 49b described above.

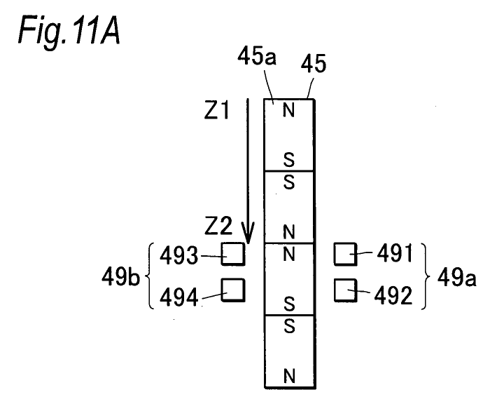

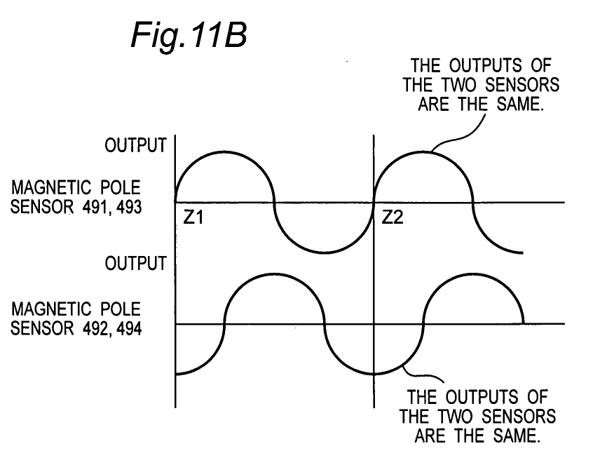

This situation will be described referring to FIGS. 11 to 13. In FIG. 11A, the axial center of the driving shaft 45 is aligned with the center axis of the coils 48 of the stator 47. In such a case, the clearances between the driving permanent magnet 45a and the four magnetic pole detection sensors 491 to 494 of the two sensor units 49a and 49b are all equal, and the outputs of the upper two magnetic pole detection sensors 491 and 493 and the outputs of the lower two magnetic pole detection sensors 492 and 494, respectively included in the sensor units 49a and 49b, are the same as shown in FIG. 11B.

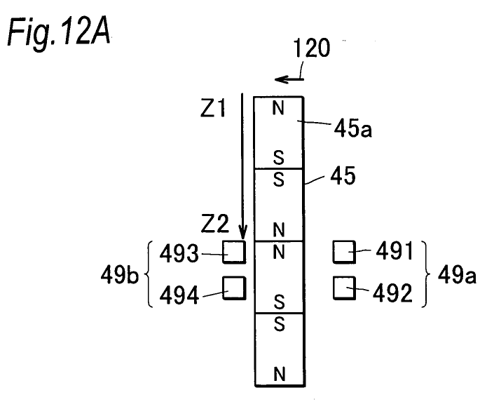

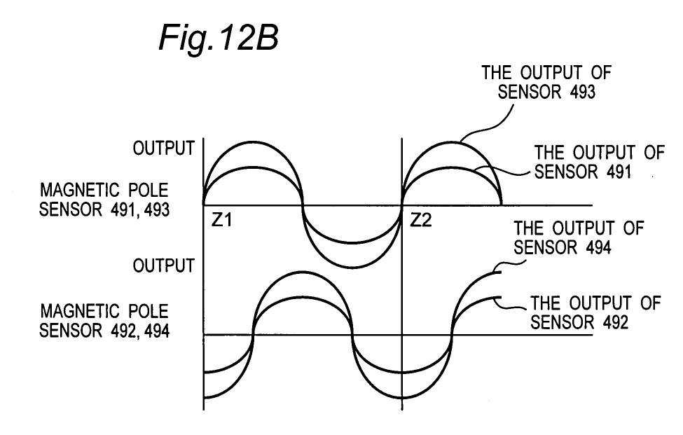

However, if the driving shaft 45 is deviated in a direction perpendicular to the Z-axis direction, as indicated by an arrow 120 as shown in FIG. 12A, the driving permanent magnets 45a become close to the sensor unit 49b and away from the sensor unit 49a. At this time, the outputs from the magnetic pole detection sensors 491 to 494 of the sensor units 49a and 49b are as shown in FIG. 12B. In other words, the upper magnetic pole detection sensor 491 of the sensor unit 49a becomes far from the driving permanent magnet 45a and its output gain becomes weak in comparison with the upper magnetic pole detection sensor 493 of the sensor unit 49b. In addition, the lower magnetic pole detection sensor 492 of the sensor unit 49a becomes far from the driving permanent magnet 45a and its output gain becomes weak in comparison with the lower magnetic pole detection sensor 494 of the sensor unit 49b.

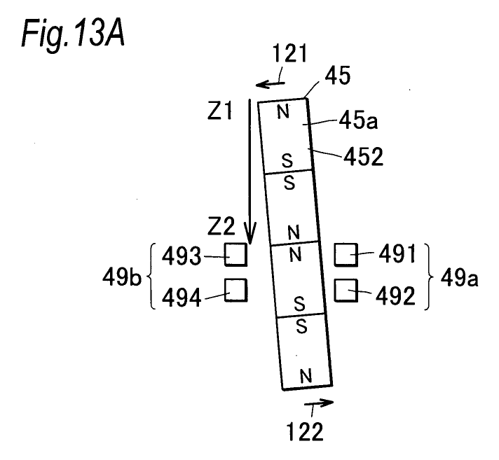

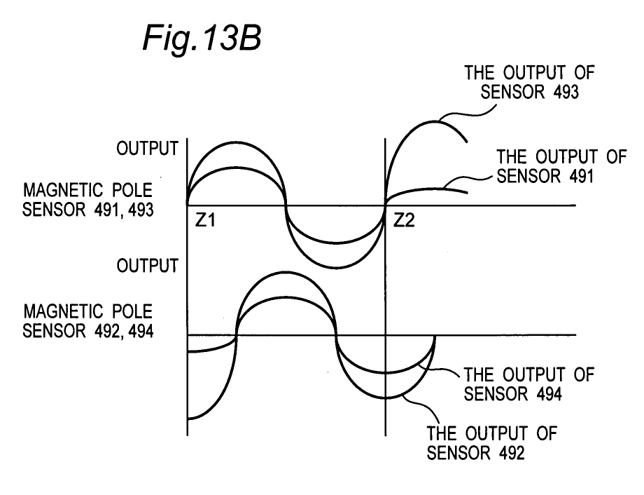

Next, if the upper portion of the driving shaft 45 is moved in a left direction in the figure as indicated by an arrow 121 and the lower portion thereof is moved in a right direction in the figure as indicated by an arrow 122 as shown in FIG. 13A, as the driving shaft 45 is moved in the Z-axis direction, the clearances between the driving permanent magnets 45a and the sensor units 49a and 49b will change. In other words, the driving shaft 45 is close to the sensor unit 49a at the position of the driving permanent magnet 451 disposed on the lower side in the Z-axis direction, and the driving shaft 45 is close to the sensor unit 49b at the position of the driving permanent magnet 452 disposed on the upper side in the Z-axis direction. Hence, the outputs of the magnetic pole detection sensors 491 to 494 of the sensor units 49a and 49b at the time when the driving shaft 45 is moved downward from Z1 to Z2 are as shown in FIG. 13B. In other words, the output of the upper magnetic pole detection sensor 491 of the sensor unit 49a decreases as the driving shaft is moved; however the output of the upper magnetic pole detection sensor 493 of the sensor unit 49b increases as the driving shaft is moved. Furthermore, in the case of the lower magnetic pole detection sensors of the sensor units 49a and 49b, the output of the magnetic pole detection sensor 492 decreases as the driving shaft is moved; however the output of the magnetic pole detection sensor 494 increases as the driving shaft is moved.

If the axial center of the driving shaft 45 is deviated or inclined from the center axis of the shaft insertion hole of the stator 47 as shown in FIGS. 12A and 13A as described above, position detection is impossible using either one of the sensor units 49a and 49b. In this embodiment, however, the outputs of the two sensor units 49a and 49b are used so that position detection is made possible even if the driving shaft 45 is deviated or inclined.

More specifically, in this embodiment, the average value of the output values of the upper magnetic pole detection sensors 491 and 493 and the output values of the lower magnetic pole detection sensors 492 and 494, provided for the two sensor units 49a and 49b included in the position detection magnetic pole sensor 49, is calculated, and the position of the driving shaft 45 is detected on the basis of the value. Since the two sensor units 49a and 49b are provided radially (symmetrically with respect to the axis) on nearly the same circumference around the center of the shaft insertion hole of the stator, even if one of the magnetic pole detection sensors decreases because the driving shaft 45 is deviated or inclined in either direction from the center axis of the stator, the output of the other magnetic pole detection sensor increases; hence, the total of the distances to the two sensor units 49a and 49b is maintained nearly constant. In other words, an error caused when the axial center of the driving shaft 45 is deviated from the center axis of the stator 47 can be absorbed by calculating the average of the outputs of the two sensor units 49a and 49b.

In the examples shown in the figures, the two magnetic pole detection sensors 491 and 493 are disposed so as to be symmetrical with respect to the axial center of the driving shaft 45 in the same plane; however, it is preferable that more sensor units 49 may be disposed to carry out accurate position detection even in various cases of positional deviation and inclination in different directions, for example, the deviation or inclination of the driving shaft 45 in the direction perpendicular to the line connecting the positions at which the two sensors are disposed. In such a case, it is preferable that the sensor units 46 may be disposed radially around the axial center of the driving shaft 45 at equal intervals in the same plane orthogonal to the axial center.

Furthermore, although the driving shaft 45 formed of plural permanent magnets 45a stacked is taken as an example in the above descriptions, even if the driving shaft 45 itself is magnetized so as to have magnetic poles, or even if the driving shaft 45 comprises a rod-shaped core member and a permanent magnet disposed so as to externally cover the core member, the method for detecting the magnetic field intensity of the magnetic poles provided for the driving shaft 45 is used in the exactly same way.

As described above, in the component mounting device 101 according to this embodiment, the driving shaft 45 constituting a part of the suction nozzle assembly 10 can be used as a component of the actuator 40 serving as a shaft type linear motor, whereby the mounting heads 4 and 14 cam be made compact. Furthermore, since the driving shaft 45 is disposed so that its movements in the X-axis direction and the Y-axis direction are restricted using the bearings 50a and 50b, the nozzle section 39 is prevented from wobbling during component mounting operation.

In addition, since the sensor units 49a and 49b having the plural magnetic pole detection sensors 491 to 494 for detecting the magnetic fields of the driving permanent magnets 45a are used to detect the position of the driving shaft 45, the driving shaft 45 can be configured so as to be able to perform θ-rotation, and the high accuracy of the position detection can be maintained even if the θ-rotation is performed.

Furthermore, since the two magnetic pole detection sensors 491 and 492 of the sensor unit 49 are disposed with a distance therebetween being approximately equal to half of the Z-axis direction dimension of one driving permanent magnet 45a, when one of the magnetic pole detection sensors detects a approximately maximum or minimum magnetic field intensity, the other magnetic pole detection sensor detects approximately zero magnetic field intensity; hence, the position can be detected directly by carrying out the detection with reference to the inner cycle angle on the basis of the outputs of the two magnetic pole detection sensors. In other words, the position detection can be carried out while an adverse effect due to the change in the states of the driving shaft and the coils is reduced, in comparison with a case in which the outputs of magnetic pole detection sensors are stored beforehand as reference values and position detection is carried out by comparison with the reference values.

In particular, when plural sensor units 49a and 49b are provided, position detection can be carried out accurately even if the clearance between the driving shaft 45 and the stator 47 is changed, by obtaining the addition average of the outputs of the magnetic pole detection sensors 491 to 491 disposed in the same position in the Z-axis direction and respectively corresponding to the sensor units 49a and 49b.

Furthermore, since the analog signals output from the sensor units 49a and 49b are A/D-converted into digital values, the resolution of detection accuracy can be raised by increasing the resolution of measuring the converted digital values. In other words, the detection accuracy can be determined using the magnetic period length determined by the length of the driving permanent magnet 45a and the measurement resolution, and the detection accuracy can be improved relatively easily by increasing processable measurement resolution using software.

The magnetic field intensity of the magnets 45a disposed at both ends in the axial direction, among the plural magnets 45a constituting the driving shaft 45, may differ from the magnetic field intensity of the magnets 45a disposed in the middle between the magnets 45a disposed at both ends. Hence, it is preferable that the magnetic pole detection sensors 491 to 494 may be provided at positions wherein it is possible to avoid the magnetic field detection of the magnets 45a disposed at both ends, or it is preferable that, even if the magnetic field is detected, the detected magnetic field is not used for position information for detecting the position of the driving shaft 45, or the output values are corrected before use.

Furthermore, the clearance between the pair of the magnetic pole detection sensors 491 and 492 disposed so as to have a clearance in the axial direction of the driving shaft 45 is not always necessary to be set to ¼ of the magnetic field period length of the driving shaft 45, but the two sensors may only be disposed so as to be able to detect the movement position of the driving shaft 45 on the basis of the magnetic field intensity signals detected by the two sensors. Furthermore, even when the phase shift of π/2 is detected, the clearance therebetween is not always necessary to be set to ¼ of the magnetic field period length, but the two magnetic pole detection sensors may be disposed so that a clearance of (n cycles+¼) is given therebetween with respect to the magnetic field period length.

Next, another form according to this embodiment will be described referring to the drawings. As having been described above, each of the mounting heads 4 and 14 is a head comprising a multi-shaft type linear motor in which plural nozzle sections 39 can be installed. In this case, the shaft type linear motors 40 for the respective plural shafts are arranged so as to be adjacent to one another, and the shaft type linear motors 40 are usually controlled so as to be operated independently using the mounting controller 101. At this time, there is no problem when the arrangement clearance among the shaft type linear motors 40 is large; however, when the clearance is small, and the linear motors are adjacent to one another, since many magnets, such as the plural permanent magnets 45a and the plural coils 48 are included in the respective shafts, the lines of magnetic force of these magnets exert influence mutually, whereby the control of the shaft type linear motors 40 may be troubled.

As described above, it is desirable that the inter-shaft pitch Px of the shaft type linear motors 40 disposed in the mounting heads 4 and 14 may be an integral plural of the arrangement pitch L of the component feeding cassettes 80, and it is preferable that each of the mounting heads 4 and 14 may be provided with as many the nozzle sections 39 as possible to raise mounting efficiency. At the same time, it is preferable that the mounting heads 4 and 14 themselves may be formed as lightweight and compact as possible to reduce the moment of inertia of the mounting heads 4 and 14 to be transferred using the XY robot 5 at the time when the heads are driven, and to facilitate the control. Hence, the specifications of the component mounting device 101 request that the arrangement pitch of the shaft type linear motors 40 may be as small as possible so as to be arranged close to one another.

Whether the control is troubled depending on how close the linear motors 40 are arranged to one another is different depending on the intensity of the magnetic forces of the permanent magnets 45a and the coils (electric magnets) 48 being used for the respective linear motors 40, and the setting cannot be done unconditionally. The degree of the trouble is particularly affected by the maximum energy product (BHmax) of the magnets, that is, the maximum of the product of the residual magnetic flux density (Br) and the magnetic coercive force (HC). In an extreme case, even if the drive current is passed through the coils 48 to drive one shaft type linear motor 40, the driving shaft 45 cannot be moved sometimes owing to adverse effects from the permanent magnets 45a of the adjacent shaft type linear motors 40 or other components.

For this reason, the shaft type linear motors 40 are required conventionally to be disposed so as to have a sufficient clearance to prevent the control from being troubled; this is inevitably resulted in causing problems, for example, the number of the nozzle sections 39 to be installed in each of the mounting heads 4 and 14 is limited, or the mounting heads 4 and 14 are made much larger than necessary. In this form, these problems are eliminated, and the mounting heads 4 and 14 can be made compact.

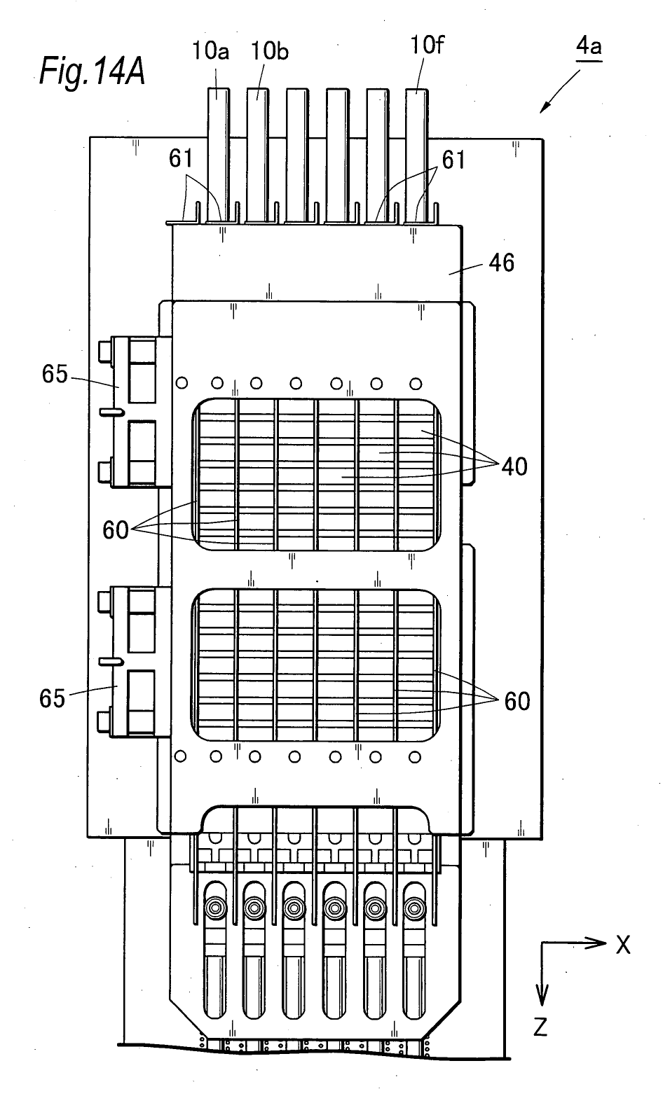

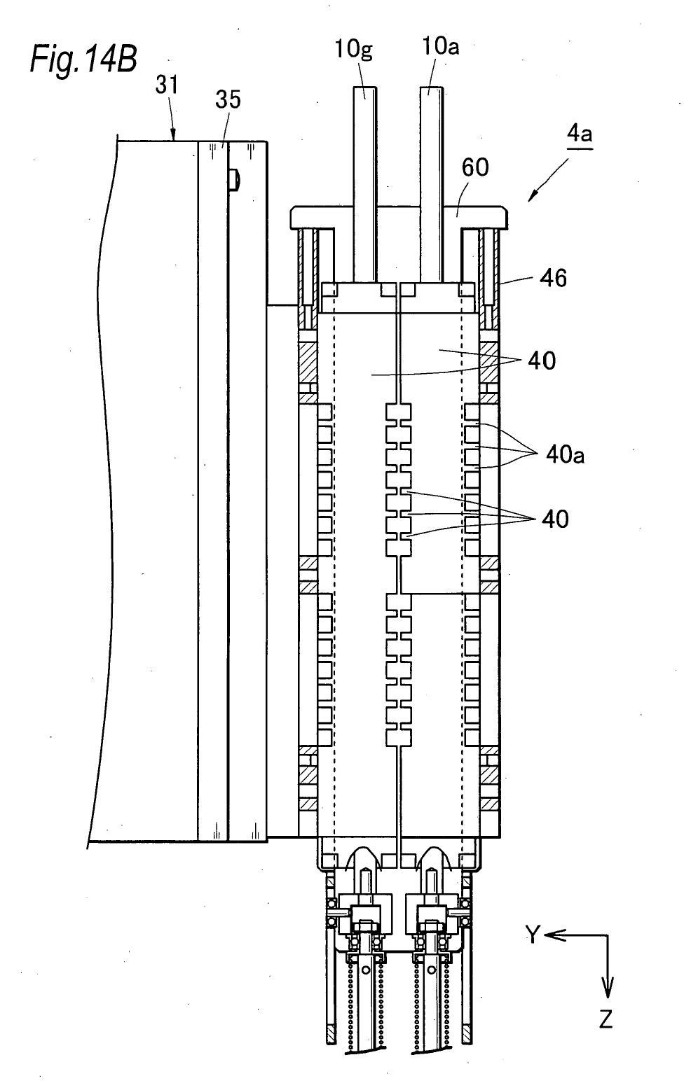

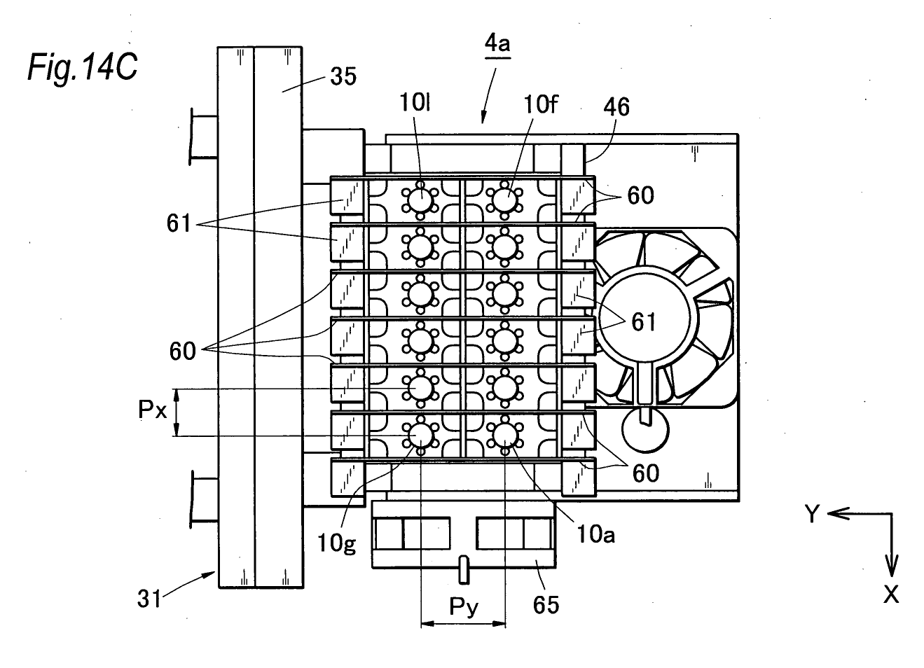

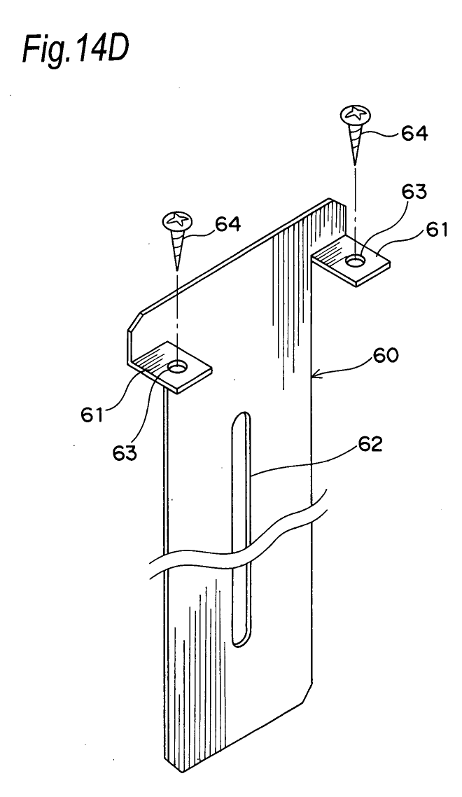

FIG. 14A is a front view showing the housing 46 of a mounting head 4a according to this form, and six suction nozzle assemblies 10a to 10f are arranged inside and on the front face side of the housing 46 (the suction nozzle assemblies 10g to 10l on the second row are arranged behind these). The shaft type linear motors 40 for the suction nozzle assemblies 10a to 10f disposed so as to be arranged are seen through the window of the housing 46, the window being formed in the center. In the mounting head 4a according to this form, magnetic force shielding members 60 (seven members in total in the example shown in the figure) are disposed between the adjacent shaft type linear motors 40 and on the outside of each of the shaft type linear motors 40 positioned on both ends in a direction perpendicular to the face of the figure so as to pass through the housing 46 in the vertical direction. In other words, each of all the shaft type linear motors 40 disposed is provided with the magnetic force shielding members 60 on both sides thereof in the X-axis direction in the figure. The magnetic force shielding member 60 is secured to the housing 46 using installing sections 61 provided at the upper end and bent into an L-shape, and the lower end of which is extended to the position being equal to the lowermost movement position of the driving shaft 45, not shown, of the shaft type linear motor 40. On the right side of the figure, two fans 65 described later are installed to cool the suction nozzle assemblies 10.

The purpose of shielding the interaction due to the lines of magnetic force from the adjacent linear motors 40 can be sufficiently attained by providing the five magnetic force shielding members 60 at the intermediate positions between the adjacent linear motors 40. However, if the magnetic force shielding members 60 are disposed in this way, the lines of magnetic force generated at the magnets and the electric magnets of the linear motors 40 positioned at both ends are not stable, and the control of the linear motors 40 becomes difficult; hence, it is preferable that the magnetic force shielding members 60 may also be disposed similarly on the outside of the linear motors 40 positioned at both ends, regardless of trouble due to magnetic forces.

FIG. 14B is a side-sectional view showing the mounting head 4a shown in FIG. 14A. In the figure, the mounting head 4a is secured to the installation face 35 of the mounting head moving section 31, the two suction nozzle assemblies 10a and 10g disposed on the front sides of the first and second rows in the state shown in the figure are shown (the other suction nozzle assemblies are disposed behind these). Numerous fins 40a for cooling the heat generated from the coils 48, disposed inside and not shown, are provided on both the left and right sides of each of the shaft type linear motors 40 shown in the central portion. At the central portions of the suction nozzle assemblies 10a and 10b being most liable to generate heat, air is introduced and passed through the interior of the housing 46 in the direction perpendicular to the face of the figure using the above-mentioned fans 65 (see FIG. 14A) to enhance the cooling effect.

In the side view of FIG. 14B, the magnetic force shielding member 60 is shown in the width direction, although the member is shown in the thickness direction in FIG. 14A. As shown in the figure, the magnetic force shielding member 60 according to this form is formed of a single plate so as to be able to simultaneously cover the suction nozzle assemblies 10 disposed in the first and second rows.

FIG. 14C is a top view showing the mounting head 4a also according to this form. As clearly shown in the figure, each of the magnetic force shielding members 60, seven in total, is secured to the upper portion of the housing 46 at the installing section 61 formed by bending the upper end portion of the member (in the figure, fastening means, such as bolts, are not shown), and is extended in the Y-axis direction in the figure so as to cover the two suction nozzle assemblies 10 in the first and second rows. In addition, in this embodiment, the clearance pitch Py between the suction nozzle assemblies 10 in the first and second rows in the Y-axis direction is set so as to be larger than the clearance pitch Px of the suction nozzle assemblies arranged in the X-axis direction (Py>Px); hence, even if the magnetic force shielding member 60 is not provided between the suction nozzle assemblies provided in the Y-axis direction in the figure, the respective shaft type linear motors 40 are controlled without causing trouble. However, if shielding members are required in the Y-axis direction, shielding members similar to the magnetic force shielding members 60 can be disposed. The cooling fans 65 for forcibly passing air between the above-mentioned suction nozzle assemblies 10a and 10b to perform cooling are shown on the lower side of the figure.

FIG. 14D shows an actual example of the magnetic force shielding member 60 being used in this form. In the figure, it is preferable that the magnetic force shielding member 60 may be made of a ferromagnetic material, such as a steel plate; however, without being limited to this, the member may be made of other materials, provided that the materials can shield lines of magnetic force. The example shown in the figure is made simply by punching and bending a steel plate. The installing sections 61 being bent into an L-shape are provided at the upper portion thereof, and fastening screws 64 are inserted into the fastening holes 63 formed in the installing sections 61, whereby the magnetic force shielding member is secured to the upper end of the housing 46 of the mounting head 4a.

The slot 62 formed in the central portion of the magnetic force shielding member 60 is a hole through which air passes when the cooling air for cooling the heat generated from the shaft type linear motors 40 is introduced so as to pass through in the X-axis direction of the above-mentioned mounting head 4a. The slot 62 is not necessary when the linear motors 40 are not arranged in two rows.

When this kind of magnetic force shielding member 60 is provided, the lines of magnetic force generated from the magnets of the shaft type linear motor 40 located at least on one side of the magnetic force shielding member are prevented from interacting with the lines of magnetic force generated from the magnets of the other adjacent shaft type linear motor 40; as a result, a closed loop of lines of magnetic force, connected to the magnets of the linear motor itself is formed. Hence, the two shaft type linear motors 40 are prevented from being adversely affected each other by the magnets of the mating linear motor, and the shaft type linear motors 40 are controlled without causing trouble.

According to the experiments conducted by the inventors of the present application, a shaft type linear motor 40 that had not been driven at all even when a drive current had been applied to the coils 48 was able to be driven without causing trouble by simply inserting only one steel plate. The thickness of the steel plate differs depending on the specifications of the magnet, such as magnetic field intensity; a sufficient effect is obtained even when the thickness is, for example, 1 mm or less (e.g., approximately 0.1 to 0.5 mm). More specifically, it is preferable that the thickness may be 0.1 to several mm.

In this embodiment, the magnetic force shielding member 60 is used together with the position detection magnetic pole sensor 49 that detects the movement position of the driving shaft 45 using the permanent magnets 45a provided for the driving shaft 45, and this kind of combination is preferable because the advantages of the two can be shared; however, the magnetic force shielding member 60 according to this form is also applicable to a shaft type linear motor provided with other position detection mechanisms, such as a linear scale and an optical sensor, in a similar way.

Although the shaft type linear motor and the method for detecting the movement position of the shaft for driving the linear motor according to the present invention have been described, the present invention is not limited to the application to the embodiments having been described up to now. For example, the forms applied to the mounting head of the component mounting device, described in the explanations of the embodiments, are only taken as examples; and the present invention is also applicable in a similar way to multi-shaft type linear motors being used for other uses. In addition, although a type with two mounting heads operating independently is taken as an example of the component mounting device in the embodiment, the apparatus may be a type equipped with one mounting head or three or more mounting heads operating independently. Furthermore, the present invention is not limited to be applied to an XY robot type, but is also applicable to a rotary-type component mounting device that is provided with plural suction nozzle assemblies disposed circumferentially and carries out component mounting using an index rotating intermittently. In the present specification, even this index is included in the concept of a transfer robot.

By appropriate combination of any given embodiments of the various embodiments described above, effects of the respective embodiments can be produced.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

1-18. (canceled)

19. A mounting head for taking out a component supplied to a component feeding section and mounting the component at mounting position on circuit board, comprising:
a shaft type linear motor comprising a hollow stator formed of plural ring-shaped coils being disposed concentrically and linearly; a tubular driving shaft provided with north and south magnetic poles being disposed alternately at approximately equal intervals in an axial direction thereof, and inserted into a hollow section of the stator, for moving in the axial direction owing to interaction between the plural coils and the magnetic poles; sensor unit including at least a pair of magnetic detection sensors disposed with a predetermined clearance provided therebetween in the axial direction so as to be opposed to an outer circumferential face of the driving shaft, for outputting the magnetic field intensities of the magnetic poles provided for the driving shaft, detected by the respective magnetic detection sensors, as magnetic field intensity signals; and a detection section for receiving the output plural magnetic field intensity signals and detecting a movement position of the driving shaft with respect to the stator based on the magnetic field intensity signals,
a spline shaft connected to the driving shaft of the shaft type linear motor,
a nozzle section connected to the spline shaft and being capable of holding the component by suction, and
a ball spline nut being fitted on the spline shaft, slidable in an axial direction of the spline shaft, and connected to a rotation drive source so as to be rotatable together with the spline shaft, wherein
the driving shaft and the spline shaft are respectively hollow and integrally connected to each other, and an air suction path is formed from an upper portion of the driving shaft to the nozzle section to communicate the upper end and with the nozzle section, and
a height position of the nozzle section moved in the axial direction of the spline shaft by a drive of the shaft type linear motor is detected by the detection section of the shaft type linear motor.

20. The mounting head according to claim 19, wherein the magnetic poles provided for the driving shaft of the shaft type linear motor are magnetic poles magnetized on the driving shaft itself.

21. The mounting head according to claim 19, wherein the driving shaft of the shaft type linear motor comprises a rod-shaped core member and permanent magnets disposed so as to externally cover the rod-shaped core member, and the magnetic poles provided for the driving shaft are magnet poles of the permanent magnets for the external covering.

22. The mounting head according to claim 19, wherein the driving shaft of the shaft type linear motor comprises plural permanent magnets stacked and secured continuously in the axial direction so that a same poles thereof, the south magnetic poles or the north magnetic poles, are brought into contact with each other, and the magnetic poles provided for the driving shaft are poles of plural permanent magnets.

23. The mounting head according to claim 19, wherein the stator has bearing sections for restraining deviation of the driving shaft in a direction intersecting an axis of the driving shaft of the shaft type linear motor or restraining inclination of the driving shaft with respect to the axis.

24. The mounting head according to claim 19, wherein at least a pair of magnetic pole detection sensors of the sensor unit is disposed with a clearance provided therebetween so that in a case where one of the magnetic pole detection sensors detects an approximately maximum or minimum magnetic field intensity, the other magnetic pole detection sensor detects an approximately zero magnetic field intensity.

25. The mounting head according to claim 19, wherein the sensor unit is provided plural units disposed radially around a center axis of the hollow section of the stator,
the detection section detects the movement position of the driving shaft while correcting a deviation of the driving shaft in a direction intersecting an axis of the driving shaft or correcting a change in the magnetic field intensities due to an inclination of the driving shaft with respect to the axis based on the plural magnetic field intensity signals output respectively from the plural sensor units.

26. The mounting head according to claim 19, comprising a plurality of the shaft type linear motors disposed in parallel with axes thereof.

27. The mounting head according to claim 26, further comprising a magnetic force shielding member the for eliminating trouble due to magnetic forces between adjacent shaft type linear motors among the plural shaft type linear motors.

28. The mounting head according to claim 27, wherein the magnetic force shielding member is made of a ferromagnetic material that is disposed between the adjacent shaft type linear motors so that each of lines of magnetic force generated from one shaft type linear motor does not interact with lines of magnetic force generated from the shaft type linear motor being adjacent thereto.

29. The mounting head according to claim 28, wherein in a case where the shaft type linear motor is adjacent to another shaft type linear motor only on one side and no shaft type linear motor is present on the other side being axially symmetrical with the one side, magnetic force shielding members are provided further on the other side.

30. The mounting heading according to claim 19, wherein the sensor unit is disposed between the coil and the ball spline nut.

31. A component mounting device comprising a component feeding section for feeding components continuously; a mounting head for taking out the components from the component feeding sections and mounting the components on a circuit board; a robot for transferring the mounting head, a board transferring/holding device for loading and holding the circuit board; and a mounting controller for controlling whole operations, the component mounting device being configured to take out the components from the component feeding sections by suction and to mount the components at mounting positions on the circuit board by blowing using the nozzle sections installed in the mounting head, wherein
the mounting head is the mounting head according to claim 19.

32. The mounting head according to claim 19, wherein the detection section comprises:
a resolution table for storing information regarding a length between the magnetic poles for each of magnetic field periods, the poles being provided for the driving shaft,
an AID conversion circuit for converting the magnetic field intensity signals output from the sensor unit into digital values;
a pulse counter for dividing the length between the magnetic poles for the magnetic field period based on plural drive pulses and counting the drive pulses for each magnetic field period; and
an arithmetic operation section for detecting a movement amount of the driving shaft based on information regarding the length between the magnetic poles for each of the magnetic field periods at detecting the movement position of the driving shaft.

33. The mounting head according to claim 32, wherein
the shaft type linear motor has a protruding section that is provided on the driving shaft to determine a movement range of the driving shaft, and
the arithmetic operation section detects voltage applied to the coils to judge whether the driving shaft cannot be moved by the protruding section.
